(19) United States
(12) Patent Application Publication
(10) Pub. No.: US 2013/0322563 A1
(43) Pub. Date: Dec. 5, 2013

(54) COMMUNICATION DEVICE, METHOD, COMPUTER-PROGRAM PRODUCT AND APPARATUS FOR TRANSMITTING A PILOT SEQUENCE WITH A REDUCED PEAK-TO-AVERAGE POWER RATIO CONTRIBUTION

(71) Applicants: Albert VAN ZELST, Woerden (NL); Didier Johannes Richard VAN NEE, Tull en't Waal (NL)

(72) Inventors: Albert VAN ZELST, Woerden (NL); Didier Johannes Richard VAN NEE, Tull en't Waal (NL)

(73) Assignee: QUALCOMM INCORPORATED, San Diego, CA (US)

(21) Appl. No.: 13/487,811

(22) Filed: Jun. 4, 2012

(51) Int. Cl. H04B 1/02

(52) U.S. Cl. 375/295

(57) ABSTRACT

A communication device for transmitting a pilot sequence is described. The communication device includes pilot generation circuitry configured for generating a pilot sequence with a reduced peak-to-average power ratio contribution after rotation. The communication device also includes transmitter circuitry configured for transmitting the pilot sequence.

### TECHNICAL FIELD

The present disclosure relates generally to communication systems. More specifically, the present disclosure relates to a communication device, method, computer-program product and apparatus for transmitting a pilot sequence with a reduced peak-to-average power ratio contribution.

### BACKGROUND

Communication systems are widely deployed to provide various types of communication content such as data, voice, video and so on. These systems may be multiple-access systems capable of supporting simultaneous communication of multiple communication devices (e.g., wireless communication devices, access terminals, etc.) with one or more other communication devices (e.g., base stations, access points, etc.).

Use of communication devices has dramatically increased over the past few years. Communication devices often provide access to a network, such as a Local Area Network (LAN) or the Internet, for example. Other communication devices (e.g., access terminals, laptop computers, smart phones, media players, gaming devices, etc.) may wirelessly communicate with communication devices that provide network access. Some communication devices comply with certain industry standards, such as the Institute of Electrical and Electronics Engineers (IEEE) 802.11 (e.g., Wireless Fidelity or “Wi-Fi”) standards. Communication device users, for example, often connect to wireless networks using such communication devices.

As the use of communication devices has increased, advancements in communication device capacity, reliability and efficiency are being sought. Systems and methods that improve communication device capacity, reliability and/or efficiency may be beneficial.

### SUMMARY

A communication device for transmitting a pilot sequence is disclosed. The communication device includes pilot generation circuitry configured for generating a pilot sequence with a reduced peak-to-average power ratio contribution after rotation. The communication device also includes transmitter circuitry configured for transmitting the pilot sequence. The communication device may also include rotation circuitry configured for rotating the pilot sequence such that the pilot sequence has a lowest peak-to-average power ratio contribution. The pilot generation circuitry may be further configured to multiply the pilot sequence by one or more pseudo-random noise values. The communication device may be an access point. The communication device may be an access terminal.

The pilot sequence may include a pilot sequence [1 1 1 −1 −1 1 1 1]. The pilot sequence may be included in four subbands and pilot symbols corresponding to the four subbands may be rotated using a rotation factor [1 −1 −1 −1] or its inverse. The four subbands may each be 20 megahertz (MHz) subbands. The pilot sequence may include a pilot sequence [1 1 −1 1 1 −1 −1 −1] or its inverse after rotation.

The pilot sequence may be combined with data. The transmitter circuitry may be further configured to transmit the data. The pilot sequence and the data may include a very high throughput data (VHT-DATA) field. The pilot sequence may include one or more orthogonal frequency-division multiplexing (OFDM) symbols.

A method for transmitting a pilot sequence by a communication device is also disclosed. The method includes generating a pilot sequence with a reduced peak-to-average power ratio contribution after rotation. The method also includes transmitting the pilot sequence.

A computer-program product for transmitting a pilot sequence is also disclosed. The computer-program product includes a non-transitory tangible computer-readable medium with instructions. The instructions include code for causing a communication device to generate a pilot sequence with a reduced peak-to-average power ratio contribution after rotation. The instructions also include code for causing the communication device to transmit the pilot sequence.

An apparatus for transmitting a pilot sequence is also disclosed. The apparatus includes means for generating a pilot sequence with a reduced peak-to-average power ratio contribution after rotation. The apparatus also includes means for transmitting the pilot sequence.

### BRIEF DESCRIPTION OF THE DRAWINGS

FIG. 1 is a block diagram illustrating one configuration of a transmitting communication device in which systems and methods for transmitting a pilot sequence may be implemented;

FIG. 2 is a diagram illustrating one example of a transmission frame that may be used in accordance with the systems and methods disclosed herein;

FIG. 3 is a flow diagram illustrating one configuration of a method for transmitting a pilot sequence;

FIG. 4 is a block diagram illustrating one example of several blocks/modules that may be used to produce a pilot sequence with a lowest peak-to-average power (PAPR) contribution;

FIG. 5 is a flow diagram illustrating a more specific configuration of a method for transmitting a pilot sequence;

FIG. 6 is a block diagram illustrating one configuration of an access point in which systems and methods for transmitting a pilot sequence may be implemented;

FIG. 7 is a diagram illustrating one example of a transmission frame that may be used in accordance with the systems and methods disclosed herein;

FIG. 8 is a flow diagram illustrating a more specific configuration of a method for transmitting a pilot sequence;

FIG. 9 is a block diagram illustrating a more detailed example of several blocks/modules that may be used to produce a pilot sequence with a lowest peak-to-average power (PAPR) contribution;

FIG. 10 is a flow diagram illustrating one configuration of a method for using a pilot sequence with a lowest peak-to-average power ratio (PAPR) contribution; and

FIG. 11 illustrates certain components that may be included within a communication device, access point and/or access terminal.

### DETAILED DESCRIPTION

Examples of communication devices include cellular telephone base stations or nodes, access points, wireless gateways and wireless routers, for example. A communication device may operate in accordance with certain industry standards, such as the Institute of Electrical and Electronics Engineers (IEEE) 802.11a, 802.11b, 802.11g, 802.11n and/or 802.11ac (e.g., Wireless Fidelity or “Wi-Fi”) standards. Other examples of standards that a communication device may comply with include IEEE 802.16 (e.g., Worldwide Interoperability for Microwave Access or “WiMAX”), Third Generation Partnership Project (3GPP), 3GPP Long Term Evolution (LTE) and others (e.g., where a communication device may be referred to as a NodeB, evolved NodeB (eNB), etc.). While some of the systems and methods disclosed herein may be described in terms of one or more standards, this should not limit the scope of the disclosure, as the systems and methods may be applicable to many systems and/or standards.

Some communication devices (e.g., access terminal, client device, client station, etc.) may wirelessly communicate with other communication devices. Some communication devices may be referred to as mobile devices, mobile stations, subscriber stations, user equipments (UEs), remote stations, access terminals, mobile terminals, terminals, user terminals, subscriber units, etc. Additional examples of communication devices include laptop or desktop computers, cellular phones, smart phones, wireless modems, e-readers, tablet devices, gaming systems, etc. Some of these communication devices may operate in accordance with one or more industry standards as described above. Thus, the general term “communication device” may include communication devices described with varying nomenclatures according to industry standards (e.g., access terminal, user equipment (UE), remote terminal, access point, base station, Node B, evolved Node B (eNB), etc.).

Some communication devices may be capable of providing access to a communications network. Examples of communications networks include, but are not limited to, a telephone network (e.g., a “land-line” network such as the Public-Switched Telephone Network (PSTN) or cellular phone network), the Internet, a Local Area Network (LAN), a Wide Area Network (WAN), a Metropolitan Area Network (MAN), etc.

As used herein, the terms “compensate,” “compensation,” “compensate for,” “correct,” “correction,” “correct for” and other forms of “compensate” or “correct” indicate some level of compensation or correction. That is, the terms may indicate some reduction of offsets/errors or at least some action taken in an effort to reduce offsets/errors. In other words, compensating for frequency offsets or errors may only reduce the frequency offsets or errors. Thus, some amount of frequency offsets or errors may remain after “compensation” or “correction.” For instance, a “correct” computation may mean a “more accurate” computation.

In this specification and the appended claims, it should be clear that the term “circuitry” is construed as a structural term and not as a functional term. For example, circuitry can be an aggregate of circuit components, such as a multiplicity of integrated circuit components, in the form of processing and/or memory cells, units, blocks and the like. For instance, the term “circuitry” may refer to application-specific integrated circuits (ASICs), field-programmable gate arrays (FPGAs), processors and/or other circuit components such as transistors, resistors, capacitors, inductors, latches, etc.

In IEEE 802.11, a communication device may send pilot symbols to another communication device. The pilot symbols may be sent using one or more spatial streams, for example. In one configuration, pilot symbols may be sent in a very high throughput long training field (VHT-LTF) in additional to or alternatively from a very high throughput data (VHT-DATA) field.

In one example, for very high throughput long training fields (VHT-LTFs), pilot tones for single-user (SU) and downlink multi-user (DL-MU) may be used as follows. In the very high throughput long training fields (VHT-LTFs) (see Equation 20-29 in the IEEE 802.11n specification), a VHT-LTF mapping matrix P may be applied to all tones except for pilot tones, where P is replaced by a repetition matrix R. R has the same dimensions as P (e.g., N_{STS}×N_{LTF} or a number of space-time streams by a number of training symbols (in a long training field)). All of the rows in R are the same as the first row of the P matrix.

In one example of the very high throughput data (VHT-DATA) field, all space-time streams may transmit the same pilot sequence. The value or values of the pilot sequence are described in greater detail below. For each pilot tone, the same stream cyclic shift diversity (CSD) and spatial mapping may be applied across the very high throughput long training fields (VHT-LTFs) and the very high throughput data (VHT-DATA) field. More specifically, a different CSD may be applied per spatial stream, but the pilot tones within a spatial stream may have the same CSD applied.

The systems and methods disclosed herein describe one or more pilot sequences that may be used. For example, for 20 and 40 megahertz (MHz) transmissions, pilot sequences for one spatial stream as given by IEEE 802.11n may be used. For 80 MHz transmissions, the pilot sequence illustrated in Table (1) may be used. It should be noted that the sequence illustrated in Table (1) may also provide an extension from a 20 MHz pilot sequence to a 40 MHz pilot sequence.

TABLE (1)
80 MHz Pilot Sequence

| 40 MHz Pilot Sequence (1 Spatial Stream) | | | | | | | |
|---|---|---|---|---|---|---|---|
| 20 MHz Pilot Sequence (1 Spatial Stream) | | | | | | | |
| Ψ₀ | Ψ₁ | Ψ₂ | Ψ₃ | Ψ₄ | Ψ₅ | Ψ₆ | Ψ₇ |
| 1 | 1 | 1 | −1 | −1 | 1 | 1 | 1 |

The pilot sequence illustrated in Table (1) may be a 40 MHz pilot sequence for one space-time stream (e.g., N_{STS}=1) extended with a [1, 1] on the right (under Ψ₆ and Ψ₇) (where N_{STS} is a number of space-time streams). This sequence may result in the lowest peak-to-average power ratio (PAPR) on the pilot tones after applying a [1 −1 −1 −1] rotation (or a [−1 1 1 1] rotation, for example) on 20 MHz subbands. For example, some of the pilot sequences described herein (in Tables (1) and (2), for example) may provide the smallest (e.g., smallest or lowest theoretical) contribution of the PAPR of OFDM symbols. In one approach, the PAPR may be computed as follows. In this approach, the PAPR may be computed according to the contribution of just the pilot tones. A pilot mapping may be generated (for 8 pilot tones with a +1 or −1 mapping per tone, there are 256 possible pilot mappings) and a PAPR contribution of the pilot tones may be computed for a 4× oversampled inverse fast Fourier transform (IFFT) as follows. The 1024 tone inputs to the 1024-point IFFT may be set to zero. The pilot mapping may be used on the following pilot indices pilot_inds=mod([−103 −75 −39 −11 11 39 75 103], 1024). The IFFT may be computed. The absolute value (abs) of each output may be taken and squared. The PAPR may be computed by taking the maximum of the squared abs outputs and dividing it by the mean of the squared abs outputs. It should be noted that the PAPR of an OFDM symbol is the peak power divided by the average power of an (N-tone) OFDM symbol (in the time domain).

In one configuration, the PAPR may be computed before runtime, with a particular pilot sequence selected for runtime. In another configuration, the PAPR may be computed at runtime and may be used to select one of the pilot sequences with reduced or lowest PAPR.

It should be noted that this approach may be used to determine other pilot sequences that have a reduced PAPR. The systems and methods disclosed herein may be applied to use pilot sequences that may not have the lowest PAPR, but have a reduced PAPR compared to other pilot sequences. As used herein, a pilot sequence with a lowest PAPR may also be used to refer to other pilot sequences that do not have a lowest PAPR, but that have a reduced PAPR if allowed by context.

In one configuration (e.g., in IEEE 802.11ac), the pilot mapping on all N_{STS} streams may be the same (except for possible different CSDs per stream, for example). As follows hereafter, an example application of a pilot sequence for a 20 MHz transmission is given, followed by an example application of a pilot sequence for a 40 MHz transmission. Then, an example application of a pilot sequence for an 80 MHz transmission is given.

In one configuration, a pilot sequence for a 20 MHz transmission may be applied as follows. The pilot tone mapping in a 20 MHz transmission is illustrated in Equation (1).

pₙ^{{-21,-7,7,21}}={Ψ_{1,n mod 4}⁽¹⁾,Ψ_{1,(n+1)mod 4}⁽¹⁾,Ψ_{1,(n+2)mod 4}⁽¹⁾,Ψ_{1,(n+m)mod 4}⁽¹⁾} (1)

In Equation (1), Ψ_{1,m}⁽¹⁾ represents pilot symbols in the pilot sequence and is given by the N_{STS}=1 row of Table 20-18 of the IEEE 802.11n standard. In Equation (1), P is the pilot sequence and n is a very high throughput data (VHT-DATA) symbol index starting at 0. Including a pseudo-random scrambling sequence, the pilot value for the kth tone (with k={−21, −7, 7, 21}) is p_{n+z}Pₙ^{k}, where z=4 for very high throughput (VHT), and where pₙ is defined in Section 17.3.5.9 of IEEE 802.11 specifications.

In one configuration, a pilot sequence for a 40 MHz transmission may be applied as follows. The pilot tone mapping in a 40 MHz transmission is illustrated in Equation (2).

Pₙ^{{-53,-25,-11,11,25,53}}={Ψ_{1,n mod 6}⁽¹⁾,Ψ_{1,(n+1)mod 6}⁽¹⁾,Ψ_{1,(n+2)mod 6}⁽¹⁾, . . . Ψ_{1,(n+3)mod 6}⁽¹⁾,Ψ_{1,(n+4)mod 6}⁽¹⁾,Ψ_{1,(n+5)mod 6}⁽¹⁾} (2)

In Equation (2), Ψ_{1,m}⁽¹⁾ represents pilot symbols in the pilot sequence and is given by the N_{STS}=1 row of Table 20-19 of the IEEE 802.11n standard. In Equation (2), P is the pilot sequence and n is a very high throughput data (VHT-DATA) symbol index starting at 0. Including a pseudo-random scrambling sequence, the pilot value for the kth tone (with k={−53, −25, −11, 11, 25, 53}) is p_{n+z}Pₙ^{k}, where z=4 for very high throughput (VHT) and where pₙ is defined in Section 17.3.5.9 of IEEE 802.11 specifications. It should be noted that the pilot sequence illustrated does not yet include a rotation per 20 MHz subband.

In one configuration, a pilot sequence for an 80 MHz transmission may be applied as follows. The pilot tone mapping in an 80 MHz transmission is illustrated in Equation (3).

Pₙ^{{-103,-75,-39,-11,11,39,75,103}}={Ψ_{n mod 8},Ψ_{(n+1)mod 8},Ψ_{(n+2)mod 8},Ψ_{(n+3)mod 8}, . . . Ψ_{(n+4)mod 8},Ψ_{(n+5)mod 8},Ψ_{(n+6)mod 8},Ψ_{(n+7)mod 8}} (3)

In Equation (3), Ψ_{1,m} represents pilot symbols in the pilot sequence. In Equation (3), P is the pilot sequence and n is a very high throughput data (VHT-DATA) symbol index starting at 0. Including a pseudo-random scrambling sequence, the pilot value for the kth tone (with k={−103, −75, −39, −11, 11, 39, 75, 103}) is p_{n+z}Pₙ^{k}, where z=4 for very high throughput (VHT) and where pₙ is defined in Section 17.3.5.9 of IEEE 802.11 specifications. It should be noted that the pilot sequence illustrated does not yet include a rotation per 20 MHz subband.

More specifically, the systems and methods disclosed herein describe pilot sequences that have a reduced peak-to-average power ratio (PAPR) contribution. For instance, some of the pilot sequences described herein have a lowest PAPR contribution to an orthogonal frequency-division multiplexing (OFDM) symbol. The peak-to-average power ratio (PAPR) may be computed by transferring the frequency-domain signal into the time domain (using an inverse fast Fourier transform (IFFT)), searching for the peak power of the symbol and then deriving it using the mean or average power of the symbol. In one configuration, four 20 MHz subbands are included in an 80 MHz band. In this case, a rotation or multiplication factor [1 −1 −1 −1] (or its inverse: [−1 1 1 1], for example) may be used to produce pilot sequences (after including the rotation or multiplication factor) for eight tones resulting in the lowest peak-to-average power ratio (PAPR) contribution. These 48 pilot sequences are illustrated in Table (2) below. In other words, all eight-tone pilot sequences, where rotation is applied to the four 20 MHz subbands in 80 MHz, resulting in the lowest PAPR contribution are given in Table (2). That is, in Table (2), a rotation per 20 MHz subchannel is already included. Row 41 in Table (2) illustrates one example of a sequence that may be used for IEEE 802.11ac. Without the rotation pattern of [1 −1 −1 −1], this row or sequence is [1 1 1 −1 −1 1 1 1] (as illustrated in Table (1)). As illustrated, this row is [1 1 −1 1 1 −1 −1 −1] with rotation. It should be noted that a rotation factor or rotation values may be [1 −1 −1 −1] (or the inverse: [−1 1 1 1], for example) in accordance with the systems and methods disclosed herein. Basically, inverting the rotation factor or values (e.g., where all values may be multiplied by −1) does not change the peak-to-average power ratio (PAPR). It should be noted that in the configuration or case where the inverted rotation factor [−1 1 1 1] is used, the rotated pilot sequence may be [−1 −1 1 −1 −1 1 1 1] as illustrated in row 8 in Table (2) below. In some configurations, for 40 MHz transmissions, there may be three pilots per 20 MHz subband. In that case, the rotation values may apply to sets of three pilot tones. In some configurations, for 80 MHz transmissions, there may be two pilots per 20 MHz subband. In that case, the rotation values may apply to sets of two pilot tones.

TABLE (2)

| | Pilot Sequences with Lowest | | | | | | | |
|---|---|---|---|---|---|---|---|---|
| | Peak-to-Average Power Ratio Contribution | | | | | | | |
| 1 | −1 | −1 | −1 | −1 | −1 | 1 | 1 | −1 |
| 2 | −1 | −1 | −1 | −1 | 1 | −1 | −1 | 1 |
| 3 | −1 | −1 | −1 | 1 | −1 | −1 | 1 | −1 |
| 4 | −1 | −1 | −1 | 1 | −1 | 1 | −1 | −1 |
| 5 | −1 | −1 | −1 | 1 | 1 | −1 | 1 | 1 |
| 6 | −1 | −1 | −1 | 1 | 1 | 1 | −1 | 1 |
| 7 | −1 | −1 | 1 | −1 | −1 | −1 | −1 | 1 |
| 8 | −1 | −1 | 1 | −1 | −1 | 1 | 1 | 1 |
| 9 | −1 | −1 | 1 | −1 | 1 | −1 | −1 | −1 |
| 10 | −1 | −1 | 1 | −1 | 1 | 1 | 1 | −1 |
| 11 | −1 | −1 | 1 | 1 | −1 | 1 | −1 | 1 |
| 12 | −1 | −1 | 1 | 1 | 1 | −1 | 1 | −1 |
| 13 | −1 | 1 | −1 | −1 | −1 | −1 | −1 | 1 |
| 14 | −1 | 1 | −1 | −1 | −1 | 1 | 1 | 1 |
| 15 | −1 | 1 | −1 | −1 | 1 | −1 | −1 | −1 |
| 16 | −1 | 1 | −1 | −1 | 1 | 1 | 1 | −1 |
| 17 | −1 | 1 | −1 | 1 | −1 | −1 | 1 | 1 |
| 18 | −1 | 1 | −1 | 1 | 1 | 1 | −1 | −1 |
| 19 | −1 | 1 | 1 | −1 | −1 | −1 | −1 | −1 |
| 20 | −1 | 1 | 1 | −1 | 1 | 1 | 1 | 1 |
| 21 | −1 | 1 | 1 | 1 | −1 | −1 | 1 | −1 |
| 22 | −1 | 1 | 1 | 1 | −1 | 1 | −1 | −1 |
| 23 | −1 | 1 | 1 | 1 | 1 | −1 | 1 | 1 |
| 24 | −1 | 1 | 1 | 1 | 1 | 1 | −1 | 1 |
| 25 | 1 | −1 | −1 | −1 | −1 | −1 | 1 | −1 |
| 26 | 1 | −1 | −1 | −1 | −1 | 1 | −1 | −1 |
| 27 | 1 | −1 | −1 | −1 | 1 | −1 | 1 | 1 |
| 28 | 1 | −1 | −1 | −1 | 1 | 1 | −1 | 1 |
| 29 | 1 | −1 | −1 | 1 | −1 | −1 | −1 | −1 |
| 30 | 1 | −1 | −1 | 1 | 1 | 1 | 1 | 1 |
| 31 | 1 | −1 | 1 | −1 | −1 | −1 | 1 | 1 |
| 32 | 1 | −1 | 1 | −1 | 1 | 1 | −1 | −1 |
| 33 | 1 | −1 | 1 | 1 | −1 | −1 | −1 | 1 |
| 34 | 1 | −1 | 1 | 1 | −1 | 1 | 1 | 1 |
| 35 | 1 | −1 | 1 | 1 | 1 | −1 | −1 | −1 |
| 36 | 1 | −1 | 1 | 1 | 1 | 1 | 1 | −1 |
| 37 | 1 | 1 | −1 | −1 | −1 | 1 | −1 | 1 |
| 38 | 1 | 1 | −1 | −1 | 1 | −1 | 1 | −1 |
| 39 | 1 | 1 | −1 | 1 | −1 | −1 | −1 | 1 |
| 40 | 1 | 1 | −1 | 1 | −1 | 1 | 1 | 1 |
| 41 | 1 | 1 | −1 | 1 | 1 | −1 | −1 | −1 |
| 42 | 1 | 1 | −1 | 1 | 1 | 1 | 1 | −1 |
| 43 | 1 | 1 | 1 | −1 | −1 | −1 | 1 | −1 |
| 44 | 1 | 1 | 1 | −1 | −1 | 1 | −1 | −1 |
| 45 | 1 | 1 | 1 | −1 | 1 | −1 | 1 | 1 |
| 46 | 1 | 1 | 1 | −1 | 1 | 1 | −1 | 1 |
| 47 | 1 | 1 | 1 | 1 | −1 | 1 | 1 | −1 |
| 48 | 1 | 1 | 1 | 1 | 1 | −1 | −1 | 1 |

The sequence illustrated in Table (1) above (which does not include the applied rotation per 20 MHz subband, i.e., in which the first two values, that are part of the lowest 20 MHz subband, are not yet multiplied by −1) is the eighth sequence illustrated in Table (2), where the applied rotation is included.

In an additional or alternative configuration, a pilot sequence may be used that results in good cyclic correlation properties. For example, the pilot sequence illustrated in Table (3) may be used in addition to or alternatively from any other pilot sequence (with lowest PAPR, for example) described herein.

TABLE (3)
80 MHz Pilot Sequence

| 40 MHz Pilot Sequence (1 Spatial Stream) | | | | | | | |
|---|---|---|---|---|---|---|---|
| 20 MHz Pilot Sequence (1 Spatial Stream) | | | | | | | |
| Ψ₀ | Ψ₁ | Ψ₂ | Ψ₃ | Ψ₄ | Ψ₅ | Ψ₆ | Ψ₇ |
| 1 | 1 | 1 | −1 | −1 | 1 | −1 | 1 |

The pilot sequence illustrated in Table (3) may be a 40 MHz pilot sequence for one space-time stream (e.g., N_{STS}=1) extended with a [−1, 1] on the right (under Ψ₆ and Ψ₇) (where N_{STS} is a number of space-time streams). This sequence may result in good cyclic correlation properties. For instance, [1 1 1 −1 −1 1 −1 1] may be a pilot sequence that reduces or minimizes cyclic correlation over frequency (compared to other possible pilot sequences, for example).

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

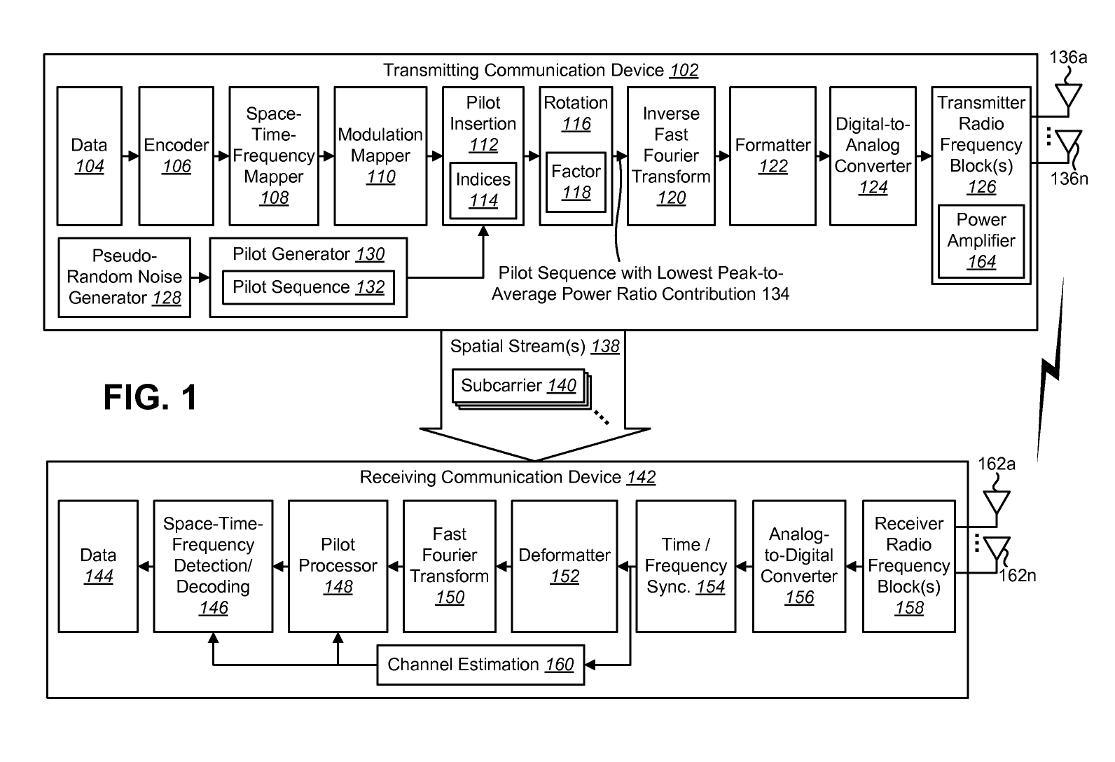

FIG. 1 is a block diagram illustrating one configuration of a transmitting communication device 102 in which systems and methods for transmitting a pilot sequence may be implemented. The transmitting communication device 102 may include an encoder 106 with an input for receiving data 104 to be transmitted to one or more receiving communication devices 142. The encoder 106 might encode data 104 for forward error correction (FEC), encryption, packeting and/or other encodings known for use with wireless transmission. The output of encoder 106 is provided to a space-time-frequency mapper 108 that maps the encoded data onto Spatial-Time-Frequency (STF) dimensions of the transmitter. The dimensions represent various constructs or resources that allow for data to be allocated. A given bit or set of bits (e.g., a grouping of bits, a set of bits that correspond to a constellation point, etc.) is mapped to a particular place among the dimensions. In general, bits and/or signals mapped to different places among the dimensions are transmitted from the transmitting communication device 102 such that they are expected to be, with some probability, differentiable at one or more receiving communication devices 142.

One or more spatial streams 138 may be transmitted from the transmitting communication device 102 such that the transmissions on different spatial streams 138 may be differentiable at a receiver (with some probability). For example, bits mapped to one spatial dimension are transmitted as one spatial stream 138. That spatial stream 138 might be transmitted on its own antenna 136 spatially separate from other antennas 136, its own orthogonal superposition over a plurality of spatially-separated antennas 136, its own polarization, etc. Many techniques for spatial stream 138 separation (involving separating antennas 136 in space or other techniques that would allow their signals to be distinguished at a receiver, for example) are known and can be used.

In the example shown in FIG. 1, there are one or more spatial streams 138 that are transmitted using the same or a different number of antennas 136a-n (e.g., one or more). In some instances, only one spatial stream 138 might be available because of inactivation of one or more other spatial streams 138.

In the case that the transmitting communication device 102 uses a plurality of frequency subcarriers 140, there are multiple values for the frequency dimension, such that the space-time-frequency mapper 108 might map some bits to one frequency subcarrier 140 and other bits to another frequency subcarrier 140. In one configuration, the frequency subcarriers 140 used for data 104 may be specified by an IEEE 802.11 standard for data subcarriers. Other frequency subcarriers 140 may be reserved as guard bands, pilot tone subcarriers, or the like that do not (or do not always) carry data 104. For example, there may be one or more data subcarriers 140 and one or more pilot subcarriers 140. It should be noted that, in some instances or configurations, not all subcarriers 140 may be excited at once (only 242 out of 256 may be excited, for example). For instance, some tones may not be excited to enable filtering. In one configuration, the transmitting communication device 102 may utilize orthogonal frequency-division multiplexing (OFDM) for the transmission of multiple subcarriers 140. It is possible, however, to use the systems and methods disclosed herein with single subcarrier systems, such as by having a space-time pilot mapping wherein pilot tones and data are time-division multiplexed onto a subcarrier 140. For instance, the space-time-frequency mapper 108 may map (encoded) data 104 to space, time and/or frequency resources according to the multiplexing scheme used.

The time dimension refers to symbol periods. Different bits may be allocated to different symbol periods. Where there are multiple spatial streams 138, multiple subcarriers 140 and multiple symbol periods, the transmission for one symbol period might be referred to as an “OFDM (orthogonal frequency-division multiplexing) MIMO (multiple-input, multiple-output) symbol.” A transmission rate for encoded data may be determined by multiplying the number of bits per simple symbol (e.g., log₂ of the number of constellations used) times the number of spatial streams 138 times the number of data subcarriers 140, divided by the length of the symbol period.

Thus, the space-time-frequency mapper 108 may map bits (or other units of input data) to one or more spatial streams 138, data subcarriers 140 and/or symbol periods. Separate spatial streams 138 may be generated and/or transmitted using separate paths. In some implementations, these paths are implemented with distinct hardware, whereas in other implementations, the path hardware is reused for more than one spatial stream 138 or the path logic is implemented in software that executes for one or more spatial streams 138. More specifically, each of the elements illustrated in the transmitting communication device 102 may be implemented as a single block/module or as multiple blocks/modules. For instance, the transmitter radio frequency block(s) 126 element may be implemented as a single block/module or as multiple parallel blocks/modules corresponding to each antenna 136a-n (e.g., each spatial stream 138). As used herein, the term “block/module” and variations thereof may indicate that a particular element or component may be implemented in hardware, software or a combination of both. For example, a block/module may be implemented in circuitry and/or in software (e.g., instructions) that are executable by circuitry (e.g., a processor).

A modulation mapper 110 maps the data provided by the space-time-frequency mapper 108 into constellations. For example, where quadrature-amplitude modulation (QAM) is used, the modulation mapper 110 might provide four bits per spatial stream 138, per data subcarrier 140, per symbol period. Furthermore, the modulation mapper 110 may output a 16-QAM constellation signal for each spatial stream 138 for each data subcarrier 140 for each symbol period. This may thus create serial-to-parallel (S/P) data paths. Other modulations may be used, such as 64-QAM, which would result in a consumption of six bits per spatial stream 138, per data subcarrier 140, per symbol period. Other variations are also possible.

The transmitting communication device 102 may include a pilot generator block/module 130. The pilot generator block/module 130 may generate a pilot sequence 132. In one example, a pilot sequence 132 may be generated such that it contributes the lowest peak-to-average power ratio to the signal or symbol transmitted by the transmitting communication device 102. In one configuration, the pilot sequence 132 may be [1 1 1 −1 −1 1 1 1] for an 80 MHz transmission. In another configuration, the pilot sequence 132 may be [1 1 1 −1 −1 1 −1 1] for an 80 MHz transmission. For instance, [1 1 1 −1 −1 1 −1 1] may be a pilot sequence 132 that reduces or minimizes cyclic correlation over frequency. A pilot sequence may be a group of pilot symbols. In one configuration, for instance, the values in the pilot sequence 132 (e.g., [1 1 1 −1 −1 1 1 1]) may be represented by a signal with a particular phase, amplitude and/or frequency. For example, a “1” may denote a pilot symbol with a particular phase and/or amplitude, while a “−1” may denote a pilot symbol with a different (e.g., opposite or inverse) phase and/or amplitude.

In one configuration, the pilot generator block/module 130 may be implemented in circuitry. For example, the pilot generator block/module 130 may be pilot generation circuitry. For instance, the pilot generation circuitry may comprise one or more dedicated hardware blocks (e.g., ASICs) or circuit components configured for generating a pilot sequence with a lowest PAPR after rotation. Additionally or alternatively, the pilot generation circuitry may execute instructions in order to generate a pilot sequence with a lowest PAPR after rotation.

The transmitting communication device 102 may include a pseudo-random noise generator 128 in some configurations. The pseudo-random noise generator 128 may generate a pseudo-random noise sequence or signal (e.g., values) used to scramble the pilot sequence 132. For example, the pilot sequence 132 for successive OFDM symbols may be multiplied by successive numbers from the pseudo-random noise sequence, thereby scrambling the pilot sequence 132 per OFDM symbol. When the pilot sequence 132 is sent to a receiving communication device 142, the received pilot sequence may be unscrambled by a pilot processor 148.

The output(s) of the modulation mapper 110 may be spread over frequency and/or spatial dimensions. A pilot insertion block/module 112 inserts pilot tones into the pilot tone subcarriers 140. For example, the pilot sequence 132 may be mapped to subcarriers 140 at particular indices 114. For instance, pilot symbols from the pilot sequence 132 may be mapped to subcarriers 140 that are interspersed with data subcarriers 140 and/or other subcarriers 140. In other words, the pilot sequence 132 or signal may be combined with the data sequence or signal. In one configuration, a direct current (DC) tone may be at index 0.

The combined data and pilot signal may be provided to a rotation block/module 116. The rotation block/module 116 may use a rotation factor 118 (e.g., multiplication factor) to rotate pilot symbols and/or data symbols. It should be noted that if a phase rotation per 20 MHz subchannel is applied, then the rotation may be applied to both pilots and data. Rotation may be performed to reduce PAPR. For example, the pilot sequence 132 may be rotated such that it becomes a pilot sequence with a lowest peak-to-average power ratio (PAPR) contribution 134. In one configuration, the rotation factor 118 may be [1 −1 −1 −1] (or [−1 1 1 1]), where each element in the rotation factor 118 corresponds to a particular subband. For instance, assume that an 80 MHz band is used for transmission of the pilot and data symbols. The 80 MHz band may include four 20 MHz subbands. Each of the rotation factor 118 elements or values [1 −1 −1 −1] may correspond to each of the four 20 MHz subbands. In the case where the first two elements or pilot symbols of a pilot sequence 132 [1 1 1 −1 −1 1 1 1] are mapped or inserted into subcarriers 140 in the lowest or first 20 MHz subband, the rotation factor 118 [1 −1 −1 −1] may rotate the pilot sequence 132 [1 1 1 −1 −1 1 1 1] such that the last six elements or symbols are inverted, resulting in a pilot sequence [1 1 −1 1 1 −1 −1 −1] with a lowest peak-to-average power ratio (PAPR) contribution 134. In other words, the last six elements of the pilot sequence 132 may be multiplied by the last three corresponding elements (−1, −1, −1) of the rotation factor 118. This rotation factor 118 [1 −1 −1 −1] may be applicable to 802.11ac specifications. In other configurations, the rotation factor 118 may be [−1 1 1 1]. The transmitting communication device 102 may additionally or alternatively generate other pilot sequences with a lowest peak-to-average power ratio (PAPR) contribution 134. Examples of these other sequences are illustrated in Table (2) above. It should be noted that the inverse of the pilot sequences illustrated in Table (2) above may additionally or alternatively be used (as inverting the sequence may not affect its peak-to-average power ratio (PAPR) contribution).

In one configuration, the rotation block/module 116 may be implemented in circuitry. For example, the rotation block/module 116 may be rotation circuitry. For instance, the rotation circuitry may comprise one or more dedicated hardware blocks (e.g., ASICs) or circuit components configured for rotating a pilot sequence such that the pilot sequence has a lowest PAPR after rotation. Additionally or alternatively, the rotation circuitry may execute instructions in order to rotate the pilot sequence such that it has a lowest PAPR.

The data and/or pilot signals (including a pilot sequence with a lowest peak-to-average power ratio (PAPR) contribution 134) are provided to an inverse fast Fourier transform (IFFT) block/module 120. The inverse fast Fourier transform (IFFT) block/module 120 converts the frequency signals of the data 104 and inserted pilot tones into time domain signals representing the signal over the spatial streams 138 and/or time-domain samples for a symbol period. In one configuration, the IFFT block/module 120 may perform a 256-point inverse fast Fourier transform (IFFT).

The time-domain signal is provided to a formatter 122. The formatter 122 (e.g., one or more formatting blocks/modules) may take the output of the inverse fast Fourier transform (IFFT) block/module 120, convert it from parallel signals to serial (P/S), add a cyclical prefix and/or perform guard interval windowing, etc.

The formatter 122 output may be provided to a digital-to-analog converter (DAC) 124. The digital-to-analog converter (DAC) 124 may convert the formatter 122 output from one or more digital signals to one or more analog signals. The digital-to-analog converter (DAC) 124 may provide the analog signal(s) to one or more transmitter radio-frequency (TX RF) blocks (e.g., transmitter circuitry) 126.

The one or more transmitter radio frequency blocks or transmitter circuitry 126 may include a power amplifier 164. The power amplifier 164 may amplify the analog signal(s) for transmission. Using a pilot sequence with a lowest peak-to-average power ratio (PAPR) contribution 134 may allow the power amplifier 164 to operate more efficiently, thus reducing power consumption. The one or more transmitter radio frequency blocks 126 may output radio-frequency (RF) signals to one or more antennas 136a-n, thereby transmitting the data 104 that was input to the encoder 106 over a wireless medium suitably configured for receipt by one or more receiving communication devices 142.

Using some of the systems and methods described herein, one or more receiving communication devices 142 may be better able to characterize the communication channel, transmitter impairments and/or receiver impairments such as phase noise and frequency offset(s). This may be used to perform detection, demodulation, decoding, etc. For instance, the pilot sequence (with lowest PAPR contribution 134) may be used to perform phase tracking. This may allow the receiving communication device 142 to be better able to decode the transmitted data in the face of distortion of the signal(s) introduced by the communication channel, transmitter impairments and/or receiver impairments. Each receiving communication device 142 may include one or more components that may perform inverse operations from operations performed by one or more components of the transmitting communication device 102.

One or more receiving communication devices 142 may receive and use signals from the transmitting communication device 102. For example, a receiving communication device 142 may use a pilot sequence with a lowest peak-to-average power ratio (PAPR) contribution 134 generated by the transmitting communication device 102 to characterize the channel, transmitter impairments and/or receiver impairments and use that characterization to improve receipt of data 104 encoded in the transmissions.

For example, a receiving communication device 142 may include one or more antennas 162a-n (which may be greater than, less than or equal to the number of transmitting communication device 102 antennas 136a-n and/or the number of spatial streams 138) that feed to one or more receiver radio-frequency (RX RF) blocks 158. The one or more receiver radio-frequency (RX RF) blocks 158 may output analog signals to one or more analog-to-digital converters (ADCs) 156. As with the transmitting communication device 102, the number of spatial streams 138 processed may or may not be equal to the number of antennas 162a-n. Furthermore, each spatial stream 138 need not be limited to one antenna 162, as various beamsteering, orthogonalization, etc. techniques may be used to arrive at a plurality of receiver streams.

The one or more analog-to-digital converters (ADCs) 156 may convert the received analog signal(s) to one or more digital signal(s). These output(s) of the one or more analog-to-digital converters (ADCs) 156 may be provided to one or more time and/or frequency synchronization blocks/modules 154. A time and/or frequency synchronization block/module 154 may (attempt to) synchronize or align the digital signal in time and/or frequency (to a receiving communication device 142 clock, for example).

The (synchronized) output of the time and/or frequency synchronization block(s)/module(s) 154 may be provided to one or more deformatters 152. For example, a deformatter 152 may receive an output of the time and/or frequency synchronization block(s)/module(s) 154, remove prefixes, etc. and/or parallelize the data for fast Fourier transform (FFT) processing.

One or more deformatter 152 outputs may be provided to one or more fast Fourier transform (FFT) blocks/modules 150. The fast Fourier transform (FFT) blocks/modules 150 may convert one or more signals from the time domain to the frequency domain. A pilot processor 148 may use the frequency domain signals (per spatial stream 138, for example) to determine one or more pilot tones (over the spatial streams 138, frequency subcarriers 140 and/or groups of symbol periods, for example) sent by the transmitting communication device 102. The pilot processor 148 may additionally or alternatively de-scramble the pilot sequence. The pilot processor 148 may use the one or more pilot sequences described herein for phase and/or frequency and/or amplitude tracking. The pilot tone(s) may be provided to a space-time-frequency detection and/or decoding block/module 146, which may detect and/or decode the data over the various dimensions. The space-time-frequency detection and/or decoding block/module 146 may output data 144 (e.g., the receiving communication device's 142 estimation of the data 104 transmitted by the transmitting communication device 102).

In some configurations, the receiving communication device 142 knows the transmit sequences sent as part of a total information sequence. The receiving communication device 142 may perform channel estimation with the aid of these known transmit sequences. To assist with pilot tone tracking, processing and/or data detection and decoding, a channel estimation block/module 160 may provide estimation signals to the pilot processor 148 and/or the space-time-frequency detection and/or decoding block/module 146 based on the output from the time and/or frequency synchronization block/module 154. Alternatively, if the de-formatting and fast Fourier transform is the same for the known transmit sequences as for the data portion of the total information sequence, the estimation signals may be provided to the pilot processor 148 and/or the space-time-frequency detection and/or decoding block/module 146 based on the output from the fast Fourier transform (FFT) blocks/modules 150.

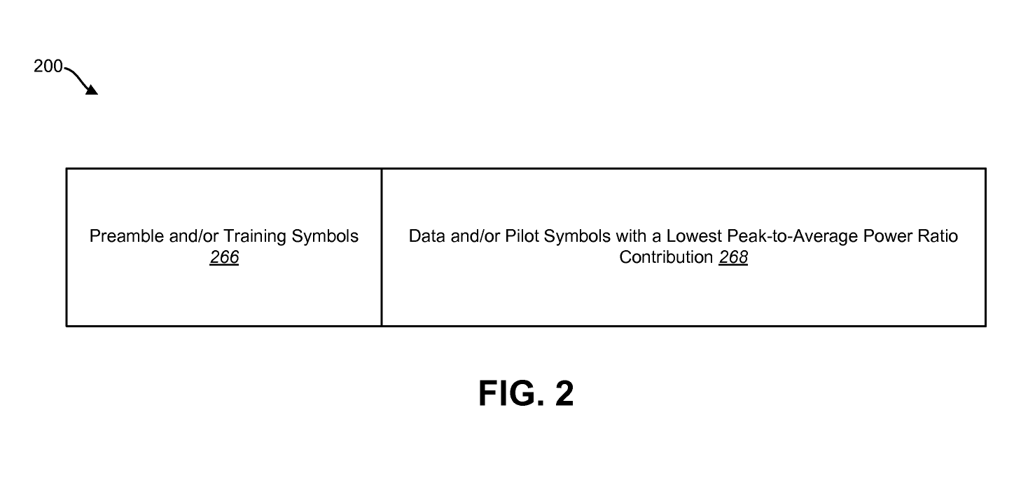

FIG. 2 is a diagram illustrating one example of a transmission frame 200 that may be used in accordance with the systems and methods disclosed herein. The frame 200 may include one or more sections or fields for preamble and/or training symbols 266. The preamble and/or training symbols 266 may include pilot symbols and/or other symbols that may be used (by a receiving communication device 142, for example) to synchronize, detect, demodulate and/or decode data included in the frame 200. In one configuration, one or more very high throughput long training fields (VHT-LTFs) may include the preamble and/or training symbols 266.

The frame 200 may additionally or alternatively include data and/or pilot symbols with a lowest peak-to-average power ratio (PAPR) 268. For example, a pilot sequence (e.g., pilot symbols) with a lowest peak-to-average power ratio (PAPR) combined with data symbols may be sent in a “data” field 268. In one configuration, a very high throughput data field (VHT-DATA) may include the data and/or pilot symbols with a lowest peak-to-average power ratio (PAPR) 268. For example, a data field 268 may include one or more orthogonal frequency-division multiplexing (OFDM) symbols. One or more of the OFDM symbols may include pilot symbols comprising a pilot sequence with a lowest PAPR contribution (to the OFDM symbols) combined with data symbols. For instance, one or more of the OFDM subcarriers may include pilot symbols while one or more of the other OFDM subcarriers may include data symbols. For instance, the pilot symbols may be used by a receiving communication device 142 to characterize the communication channel, transmitter impairments and/or receiver impairments, to track phase and/or frequency offsets, to compensate for impairments and/or errors/offsets and/or to detect, demodulate and/or decode received data.

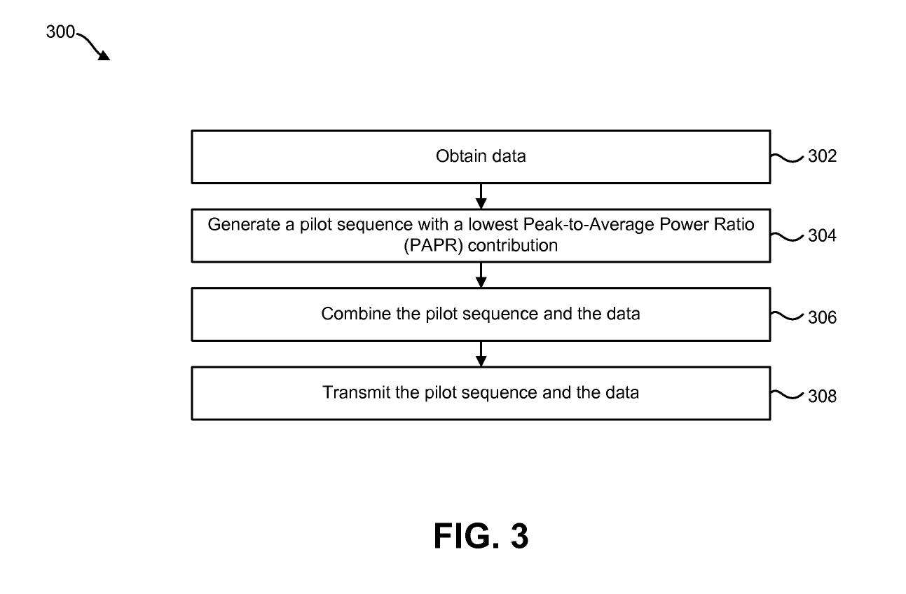

FIG. 3 is a flow diagram illustrating one configuration of a method 300 for transmitting a pilot sequence. A transmitting communication device 102 may obtain 302 data. For example, a transmitting communication device 102 may receive data 104 from a network, receive input data 104 from an input device (e.g., mouse, keyboard, microphone, controller, etc.), retrieve data 104 from local and/or removable electronic memory (e.g., a hard drive, thumb drive, external drive, random access memory (RAM), etc.) and/or obtain data 104 from some other device.

The transmitting communication device 102 may generate 304 a pilot sequence with a lowest peak-to-average power ratio (PAPR) contribution 134 (after rotation). In one configuration, the transmitting communication device 102 retrieves data from memory used to generate 304 the pilot sequence 132. For example, the data may represent the pilot sequence 132 using bits that indicate a [1 1 1 −1 −1 1 1 1] pilot sequence 132. Additionally or alternatively, the transmitting communication device 102 may generate a pilot sequence 132 that has good cyclic correlation properties (e.g., [1 1 1 −1 −1 1 −1 1]). For instance, [1 1 1 −1 −1 1 −1 1] may be a pilot sequence 132 that reduces or minimizes cyclic correlation over frequency. In one configuration, a pilot generator 130 may use this data to generate pilot symbols with a phase and/or amplitude that reflects the pilot sequence 132. For instance, the pilot generator 130 may generate a pilot sequence 132 with an orthogonal frequency-division multiplexing (OFDM) symbol with a particular amplitude and/or phase for each “1” and an OFDM symbol with a different amplitude and/or phase for each “−1.”

The transmitting communication device 102 may combine 306 the pilot sequence 132 and the data 104. For example, the transmitting communication device 102 may insert one or more pilot symbols (from the pilot sequence 132) with the data (symbols) 104. When orthogonal frequency-division multiplexing (OFDM) is used, for instance, the transmitting communication device 102 may map each of the pilot symbols from the pilot sequence 132 to a particular tone or subcarrier 140 index 114. In one configuration, the transmitting communication device 102 respectively inserts each of the eight pilot symbols in the pilot sequence 132 [1 1 1 −1 −1 1 1 1] at subcarrier 140 indices 114 {−103, −75, −39, −11, 11, 39, 75, 103}. One or more of the other subcarriers 140 may be used for data symbols.

The transmitting communication device 102 may transmit 308 the pilot sequence (e.g., pilot sequence with a lowest PAPR contribution 134) and the data 104. For example, the transmitting communication device 102 may transmit one or more OFDM symbols that include the pilot sequence (with lowest PAPR contribution 134) and the data 104 using one or more antennas 136a-n.

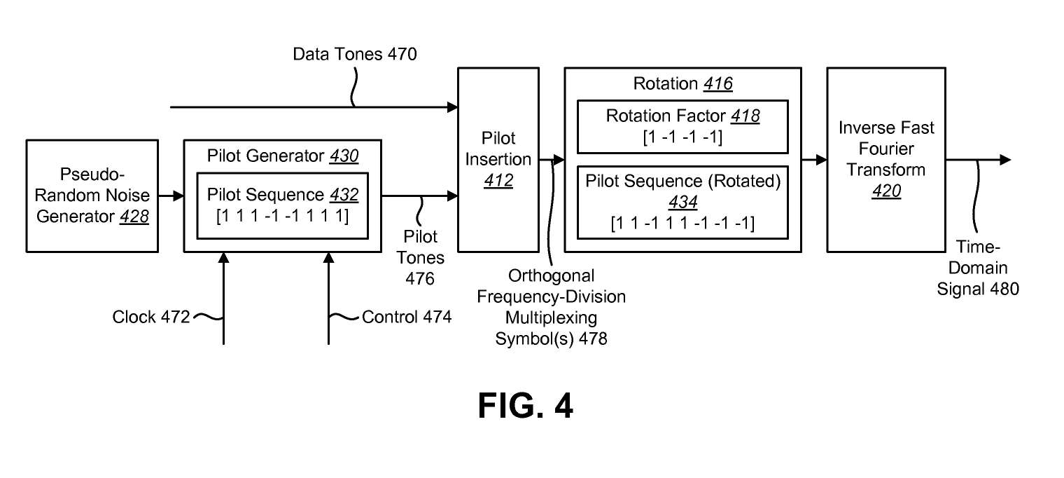

FIG. 4 is a block diagram illustrating one example of several blocks/modules that may be used to produce a pilot sequence 434 with a lowest peak-to-average power (PAPR) contribution. More specifically, FIG. 4 illustrates more detail of one example of a portion of a transmitting communication device 102. As described above, data tones 470 (from a modulation mapper 110 or the like) and pilot tones 476 (from a pilot generator 430) may be provided to an inverse fast Fourier transform (IFFT) block/module 420. For example, the data tones 470 and the pilot tones 476 (occupying different frequency subcarriers) may be applied to different taps of the IFFT block/module 420 to produce a time-domain signal 480.

In this example, the particular pilot tones 476 that are inserted by a pilot insertion block/module 412 are driven by a pilot tone generator (e.g., pilot generation circuitry) 430. The pilot tone generator 430 may determine the amplitude and/or phase of pilot tones 476. This may be done for each pilot tone 476 (where the transmitting communication device 102 provides for a plurality of pilot tone subcarriers 140), for each symbol period and/or for each spatial stream 138.

The pilot generator 430 may generate a pilot sequence 432. The values of the pilot tones 476 may be derived from a control signal 474 and optionally a pseudo-random noise (PN) generator 428. For example, the pseudo-random noise generator 428 may generate values that are multiplied by the pilot sequence 432. Furthermore, the control signal 474 may specify a particular pilot sequence 432 for use. For example, the control signal 474 may specify that a pilot sequence 432 of [1 1 1 −1] should be used for a 20 MHz transmission and that a pilot sequence 432 of [1 1 1 −1 −1 1 1 1] should be used for an 80 MHz transmission. The pilot generator 430 may also use a clock signal 472. For instance, the clock signal 472 may indicate a symbol period. A pilot sequence 432 (e.g., one or more pilot symbols) may be generated for each symbol period, for example. Thus, in a symbol period, the pilot generator 430 may specify an amplitude and/or a phase for each of one or more pilot tones 476 (over one or more spatial streams 138, for example).

In one configuration, the pilot tone 476 value for a pilot subcarrier 140 may be considered constant over a symbol period and may or may not change from one particular symbol period to the next. Thus, the values may be referred to as “pilot symbols”. The pilot generator 430 may comprise logic to determine, for a plurality of pilot tone subcarriers 140 (and/or a plurality of spatial streams 138), which pilot tone 476 symbols to provide for those subcarriers 140 during each symbol period.

In one configuration, the pilot generator 430 may generate a pilot sequence 432 [1 1 1 −1 −1 1 1 1]. For example, the pilot generator 430 may determine the amplitude and/or phase of a pilot sequence 432 of eight pilot tones 476 using the pattern [1 1 1 −1 −1 1 1 1]. For example, a particular amplitude and/or phase of eight pilot tones 476 may indicate the pattern [1 1 1 −1 −1 1 1 1]. These eight pilot tones 476 may be provided to the pilot insertion block/module 412, which may intersperse the eight pilot tones 476 amongst data tones 470 in order to generate an orthogonal frequency-division multiplexing (OFDM) symbol 478.

The OFDM symbol 478 may then be provided to a rotation block/module (e.g., rotation circuitry) 416. The rotation block/module 416 may use a rotation factor 418 to rotate the OFDM symbol 478. In one configuration, the rotation factor 418 comprises a pattern of [1 −1 −1 −1], with each element corresponding to a particular subband (e.g., a range of subcarriers 140). For example, each of the values may correspond to a 20 MHz subband in an 80 MHz band. Assume, for instance, that the first two pilot symbols in the pilot sequence 432 are included in a first 20 MHz subband. The first value of the rotation factor 418 is a −1 (in this example), and thus the first two pilot symbols in the pilot sequence 432 may be rotated, multiplied by or inverted by the −1 rotation factor 418 element. Thus, the rotation block/module 416 may produce a (rotated) pilot sequence 434 that indicates a pattern of [1 1 −1 1 1 −1 −1 −1]. The data symbols in the first 20 MHz subband may also be rotated. This (rotated) pilot sequence 434 may contribute the lowest peak-to-average power ratio to the transmitted signal.

The (rotated) pilot sequence 434 and data (as an OFDM symbol, for example) may be provided to an inverse fast Fourier transform (IFFT) block/module 420. For instance, each OFDM subcarrier may be provided to a different tap of an IFFT function. The IFFT block/module 420 may convert the (rotated) pilot sequence 434 and data to a time-domain signal 480.

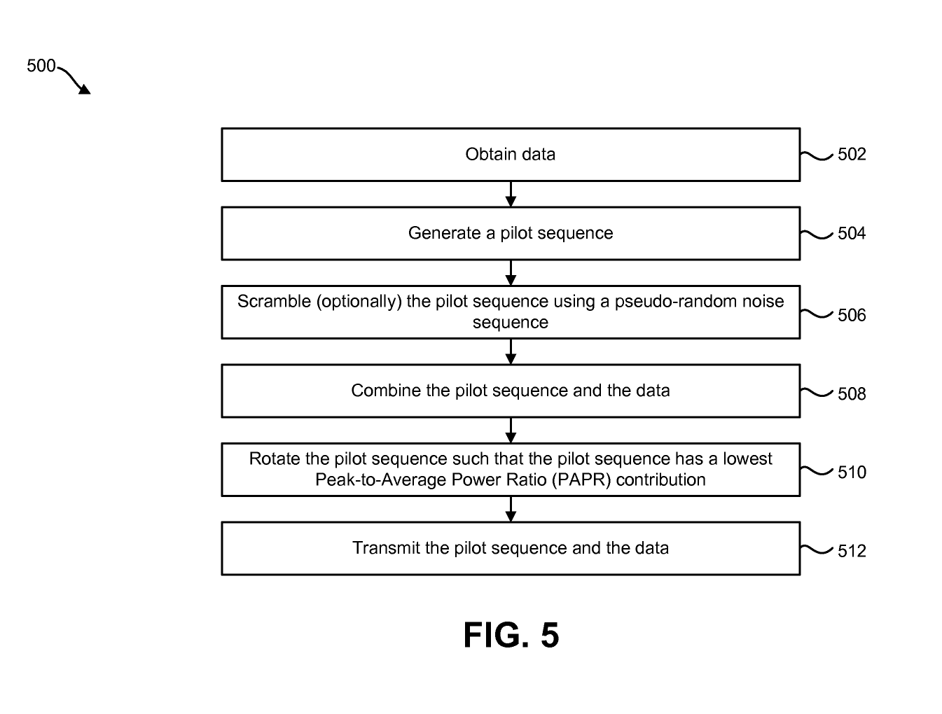

FIG. 5 is a flow diagram illustrating a more specific configuration of a method 500 for transmitting a pilot sequence. A transmitting communication device 102 may obtain 502 data 104. For example, a transmitting communication device 102 may receive data 104 from a network, receive input data 104 from an input device (e.g., mouse, keyboard, microphone, controller, etc.), retrieve data 104 from local and/or removable electronic memory (e.g., a hard drive, thumb drive, external drive, random access memory (RAM), etc.) and/or obtain data 104 from some other device.

The transmitting communication device 102 may generate 504 a pilot sequence 132. For example, the may generate a sequence of pilot symbols according to a given pattern. In one configuration, the transmitting communication device 102 retrieves pattern data from memory that may be used to generate 504 a pilot sequence 132. For example, the pattern data may represent the pilot sequence 132 using bits that indicate a [1 1 1 −1 −1 1 1 1] pilot sequence 132. In one configuration, a pilot generator 130 may use this pattern data to generate pilot symbols with a phase and/or amplitude that reflects the pilot sequence 132. For instance, the pilot generator 130 may generate a pilot sequence 132 with an orthogonal frequency-division multiplexing (OFDM) symbol with a particular amplitude and/or phase for each “1” and an OFDM symbol with a particular amplitude and/or phase for each “−1.”

The transmitting communication device 102 may optionally scramble 506 the pilot sequence 132 using a pseudo-random noise sequence. For example, the transmitting communication device 102 may use a pseudo-random noise generator 128 to generate a pseudo-random noise (PN) sequence. The pilot sequence 132 may be multiplied by the PN sequence in order to scramble 506 the pilot sequence 132.

The transmitting communication device 102 may combine 508 the pilot sequence 132 and the data 104. For example, the transmitting communication device 102 may insert one or more pilot symbols (from the pilot sequence 132) with the data (symbols) 104. When orthogonal frequency-division multiplexing (OFDM) is used, for instance, the transmitting communication device 102 may map each of the pilot symbols from the pilot sequence 132 to a particular tone or subcarrier 140 index 114. In one configuration, the transmitting communication device 102 respectively inserts each of the eight pilot symbols in the pilot sequence 132 [1 1 1 −1 −1 1 1 1] at subcarrier 140 indices 114 {−103, −75, −39, −11, 11, 39, 75, 103}. One or more of the other subcarriers 140 may be used for data symbols.

The transmitting communication device 102 may rotate 510 the pilot sequence 132 such that the pilot sequence has a lowest peak-to-average power ratio (PAPR) contribution 134. For example, the transmitting communication device 102 may multiply the pilot sequence 132 by a rotation factor 118. In one configuration, assume that an 80 MHz band is used for transmission of the pilot and data symbols. The 80 MHz band may include four 20 MHz subbands. The transmitting communication device 102 may use a rotation factor 118 [1 −1 −1 −1]. Each of the rotation factor 118 elements [1 −1 −1 −1] may correspond to each of the four 20 MHz subbands. In the case where the first two elements or pilot symbols of a pilot sequence 132 [1 1 1 −1 −1 1 1 1] are mapped or inserted into subcarriers 140 in the lowest or first 20 MHz subband, the rotation factor 118 [1 −1 −1 −1] may rotate a pilot sequence 132 [1 1 1 −1 −1 1 1 1] such that the last six elements or symbols are inverted, resulting in a pilot sequence [1 1 −1 1 1 −1 −1 −1] with a lowest peak-to-average power ratio (PAPR) contribution 134.

The transmitting communication device 102 may transmit 512 the pilot sequence (e.g., pilot sequence with a lowest PAPR contribution 134) and the data 104. For example, the transmitting communication device 102 may transmit one or more OFDM symbols that include the pilot sequence and the data 104 using one or more antennas 136a-n.

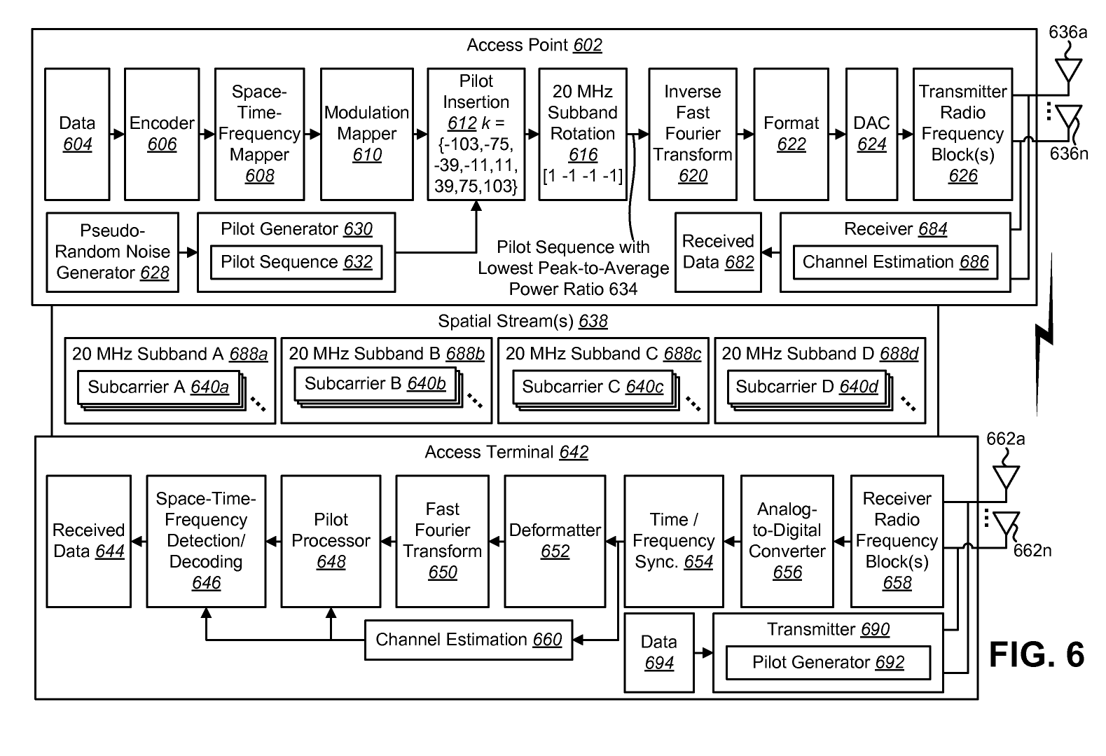

FIG. 6 is a block diagram illustrating one configuration of an access point 602 in which systems and methods for transmitting a pilot sequence may be implemented. The access point 602 may include an encoder 606 with an input for receiving data 604 to be transmitted to one or more access terminals 642. The encoder 606 might encode data for forward error correction (FEC), encryption, packeting and/or other encodings known for use with wireless transmission. The output of encoder 606 is provided to a space-time-frequency mapper 608 that maps the encoded data onto Spatial-Time-Frequency (STF) dimensions of the transmitter. The dimensions represent various constructs or resources that allow for data 604 to be allocated. A given bit or set of bits (e.g., a grouping of bits, a set of bits that correspond to a constellation point, etc.) is mapped to a particular place among the dimensions. In general, bits and/or signals mapped to different places among the dimensions are transmitted from the access point 602 such that they are expected to be, with some probability, differentiable at one or more access terminals 642.

One or more spatial streams 638 may be transmitted from the access point 602 such that the transmissions on different spatial streams 638 may be differentiable at a receiver such as an access terminal 642 (with some probability). For example, bits mapped to one spatial dimension are transmitted as one spatial stream 638. That spatial stream 638 might be transmitted on its own antenna 636 spatially separate from other antennas 636, its own orthogonal superposition over a plurality of spatially-separated antennas 636, its own polarization, etc. Many techniques for spatial stream separation (involving separating antennas 636 in space or other techniques that would allow their signals to be distinguished at a receiver, for example) are known and can be used.

In the example shown in FIG. 6, there are one or more spatial streams 638 that are transmitted using the same or a different number of antennas 636a-n (e.g., one or more). In some instances, only one spatial stream 638 might be available because of inactivation of one or more other spatial streams 638.

In the case that the access point 602 transmits using a plurality of frequency subcarriers 640a-d, there are multiple values for the frequency dimension, such that the space-time-frequency mapper 608 might map some bits to one frequency subcarrier 640 and other bits to another frequency subcarrier 640. The frequency subcarriers 640a-d used for data may be specified by an IEEE 802.11 standard for data subcarriers. Other frequency subcarriers 640 may be reserved as guard bands, pilot tone subcarriers, or the like that do not (or do not always) carry data. For example, there may be one or more data subcarriers 640 and one or more pilot subcarriers 640. In one configuration, the access point 602 may utilize orthogonal frequency-division multiplexing (OFDM) for the transmission of multiple subcarriers 640. It is possible, however, to use the systems and methods disclosed herein with single subcarrier systems, such as by having a space-time pilot mapping wherein pilot tones and data are time-division multiplexed onto a subcarrier 640. For instance, the space-time-frequency mapper 608 may map (encoded) data 604 to space, time and/or frequency resources according to the multiplexing scheme used.

In one configuration, the access point 602 may transmit and/or receive signals using an 80 MHz frequency band. As illustrated in FIG. 6, the 80 MHz frequency band may comprise four 20 MHz subbands 688a-d. For example, 20 MHz subband A 688a may include multiple subcarriers A 640a, 20 MHz subband B 688b may include multiple subcarriers B 640b, 20 MHz subband C 688c may include multiple subcarriers C 640c and 20 MHz subband D 688d may include multiple subcarriers D 640d. As described above, one or more subcarriers 640a-d in each of the 20 MHz subbands 688a-d may be used to convey pilot symbols, while other subcarriers 640a-d in each of the 20 MHz subbands 688a-d may be used to convey data symbols.

The time dimension refers to symbol periods. Different bits may be allocated to different symbol periods. Where there are multiple spatial streams 638, multiple subcarriers 640 and multiple symbol periods, the transmission for one symbol period might be referred to as an “OFDM (orthogonal frequency-division multiplexing) MIMO (multiple-input, multiple-output) symbol.” A transmission rate for encoded data may be determined by multiplying the number of bits per simple symbol (e.g., log₂ of the number of constellations used) times the number of spatial streams 638 times the number of data subcarriers 640, divided by the length of the symbol period.

Thus, the space-time-frequency mapper 608 may map bits (or other units of input data) to one or more spatial streams 638, data subcarriers 640 and/or symbol periods. Separate spatial streams 638 may be generated and/or transmitted using separate paths. In some implementations, these paths are implemented with distinct hardware, whereas in other implementations, the path hardware is reused for more than one spatial stream 638 or the path logic is implemented in software that executes for one or more spatial streams 638. More specifically, each of the components or elements illustrated in the access point 602 may be implemented as a single block/module or as multiple blocks/modules. For instance, the transmitter radio frequency block(s) 626 element may be implemented as a single block/module or as multiple parallel blocks/modules corresponding to each antenna 636a-n (e.g., each spatial stream 638).

A modulation mapper 610 maps the data provided by the space-time-frequency mapper 608 into constellations. For example, where quadrature-amplitude modulation (QAM) is used, the modulation mapper 610 might provide four bits per spatial stream 638, per data subcarrier 640, per symbol period. Furthermore, the modulation mapper 610 may output a 16-QAM constellation signal for each spatial stream 638 for each data subcarrier 640 for each symbol period. This may thus create serial-to-parallel (S/P) data paths. Other modulations may be used, such as 64-QAM, which would result in a consumption of six bits per spatial stream 638, per data subcarrier 640, per symbol period. Other variations are also possible.

The access point 602 may include a pilot generator block/module (e.g., pilot generation circuitry) 630. The pilot generator block/module 630 may generate a pilot sequence 632. A pilot sequence 632 may be generated such that it 632 contributes the lowest peak-to-average power ratio to the signal or symbol transmitted by the access point 602. In one configuration, the pilot sequence 632 may be [1 1 1 −1 −1 1 1 1] for an 80 MHz transmission.

The access point 602 may include a pseudo-random noise generator 628 in some configurations. The pseudo-random noise generator 628 may generate a pseudo-random noise sequence or signal used to scramble the pilot sequence 632. For example, the pilot sequence 632 may be multiplied by a pseudo-random noise sequence, thereby scrambling the pilot sequence 632.

The output(s) of the modulation mapper 610 may be spread over frequency and/or spatial dimensions. A pilot insertion block/module 612 inserts pilot tones for the pilot tone subcarriers 640. For example, the pilot sequence 632 may be mapped to subcarriers 640 at particular indices. In one configuration, the pilot sequence 632 of [1 1 1 −1 −1 1 1 1] may be mapped to subcarriers 640 at indices k={−103, −75, −39, −11, 11, 39, 75, 103}. These pilot subcarriers 640 may be interspersed with data subcarriers 640 and/or other subcarriers 640. In other words, the pilot sequence 632 or signal may be combined with the data sequence or signal.

The combined data and pilot signal may be provided to a 20 MHz subband rotation block/module (e.g., rotation circuitry) 616. The 20 MHz subband rotation block/module 616 may use a rotation factor to rotate pilot symbols and/or data symbols. For example, the pilot sequence 632 may be rotated such that it becomes a pilot sequence with a lowest peak-to-average power ratio contribution 634. In one configuration, the rotation factor may be [1 −1 −1 −1], where each element in the rotation factor corresponds to a particular 20 MHz subband 688a-d. For instance, assume that an 80 MHz band is used for transmission of the pilot and data symbols. The 80 MHz band may include four 20 MHz subbands 688a-d. Each of the rotation factor elements [1 −1 −1 −1] may correspond to each of the four 20 MHz subbands. In the case where two elements or pilot symbols of a pilot sequence 632 [1 1 1 −1 −1 1 1 1] are mapped or inserted into subcarriers 640a in corresponding 20 MHz subbands 688a-d, the rotation factor [1 −1 −1 −1] may rotate the pilot sequence 632 [1 1 1 −1 −1 1 1 1] such that the last six elements or symbols are inverted, resulting in a pilot sequence [1 1 −1 1 1 −1 −1 −1] with a lowest peak-to-average power ratio (PAPR) contribution 634. In other words, the last six elements of the pilot sequence 632 may be multiplied by the last three corresponding elements (−1, −1, −1) of the rotation factor [1 −1 −1 −1].

The data and/or pilot signals (including a pilot sequence with a lowest peak-to-average power ratio (PAPR) contribution 634) are provided to an inverse fast Fourier transform (IFFT) block/module 620. The inverse fast Fourier transform block/module 620 converts the frequency signals of the data and inserted pilot tones into time domain signals representing the signal over the spatial stream(s) 638 and/or time-domain samples for a symbol period.

The time-domain signal is provided to a formatter 622 (abbreviated as “Format” in FIG. 6 for convenience). The formatter (e.g., multiple formatting blocks/modules) 622 may take the output of the inverse fast Fourier transform (IFFT) block/module 620, convert it from parallel signals to serial (P/S), add a cyclical prefix and/or perform guard interval windowing, etc.

The formatter 622 output may be provided to a digital-to-analog converter (illustrated as a “DAC” for convenience in FIG. 6) 624. The digital-to-analog converter (DAC) 624 may convert the formatter 622 output from one or more digital signals to one or more analog signals. The digital-to-analog converter (DAC) 624 may provide the analog signal(s) to one or more transmitter radio-frequency (TX RF) blocks (e.g., transmitter circuitry) 626.

The one or more transmitter radio frequency blocks or transmitter circuitry 626 may include a power amplifier. The power amplifier may amplify the analog signal(s) for transmission. Using a pilot sequence with a lowest peak-to-average power ratio contribution 634 may allow the power amplifier to operate more efficiently, thus reducing power consumption. The one or more transmitter radio frequency blocks 626 may output radio-frequency (RF) signals to one or more antennas 636a-n, thereby transmitting the data 604 that was input to the encoder 606 over a wireless medium suitably configured for receipt by one or more access terminals 642.

Using some of the systems and methods described herein, one or more access terminals 642 may be better able to characterize the communication channel, transmitter impairments and/or receiver impairments such as phase noise and frequency offset(s). This may allow the access terminal 642 to be better able to decode the transmitted data in the face of distortion of the signal(s) introduced by the communication channel, transmitter impairments and/or receiver impairments. Each access terminal 642 may include one or more components or elements that may perform inverse operations from operations performed by one or more elements of the access point 602.

One or more access terminals 642 may receive and use signals from the access point 602. For example, an access terminal 642 may use a pilot sequence with a lowest peak-to-average power ratio contribution 634 generated by the access point 602 to characterize the channel, transmitter impairments and/or receiver impairments and use that characterization to improve receipt of data 604 encoded in the transmissions.

For example, an access terminal 642 may include one or more antennas 662a-n (which may be greater than, less than or equal to the number of access point 602 antennas 636a-n and/or the number of spatial streams 638) that feed to one or more receiver radio-frequency (RX RF) blocks 658. The one or more receiver radio-frequency (RX RF) blocks 658 may output analog signals to one or more analog-to-digital converters (ADCs) 656. As with the access point 602, the number of spatial streams 638 processed may or may not be equal to the number of antennas 662a-n. Furthermore, each spatial stream 638 need not be limited to one antenna 662, as various beamsteering, orthogonalization, etc. techniques may be used to arrive at a plurality of receiver streams.

The one or more analog-to-digital converters (ADCs) 656 may convert the received analog signal(s) to one or more digital signal(s). These output(s) of the one or more analog-to-digital converters (ADCs) 656 may be provided to one or more time and/or frequency synchronization blocks/modules 654. A time and/or frequency synchronization block/module 654 may (attempt to) synchronize or align the digital signal in time and/or frequency (to an access terminal 642 clock, for example).

The (synchronized) output of the time and/or frequency synchronization block(s)/module(s) 654 may be provided to one or more deformatters 652. For example, a deformatter 652 may receive an output of the time and/or frequency synchronization block(s)/module(s) 654, remove prefixes, etc. and/or parallelize the data for fast Fourier transform (FFT) processing.

One or more deformatter 652 outputs may be provided to one or more fast Fourier transform (FFT) blocks/modules 650. The fast Fourier transform (FFT) blocks/modules 650 may convert one or more signals from the time domain to the frequency domain. A pilot processor 648 may use the frequency-domain signals (per spatial stream 638, for example) to determine one or more pilot tones (over the spatial streams 638, frequency subcarriers 640 and/or groups of symbol periods, for example) sent by the access point 602. The pilot tone(s) may be provided to a space-time-frequency detection and/or decoding block/module 646, which may detect and/or decode the data over the various dimensions. The space-time-frequency detection and/or decoding block/module 646 may output received data 644 (e.g., the access terminal's 642 estimation of the data 604 transmitted by the access point 602).

In one configuration, the access terminal 642 knows the transmit sequences sent as part of a total information sequence. The access terminal 642 may perform channel estimation with the aid of these known transmit sequences. To assist with pilot tone tracking, processing and/or data detection and decoding, a channel estimation block/module 660 may provide estimation signals to the pilot processor 648 and/or the space-time-frequency detection and/or decoding block/module 646 based on the output from the time and/or frequency synchronization block/module 654. Alternatively, if the deformatting and fast Fourier transform is the same for the known transmit sequences as for the data portion of the total information sequence, the estimation signals may be provided to the pilot processor 648 and/or the space-time-frequency detection and/or decoding block/module 646 based on the output from the fast Fourier transform (FFT) blocks/modules 650.

In one configuration, an access terminal 642 may also transmit data 694 and/or pilot symbols to the access point 602. For example, an access terminal 642 may include a transmitter 690. The transmitter 690 may include a pilot generator 692. The pilot generator 692 (and/or other blocks/modules not shown in the transmitter 690) may generate a pilot sequence with a lowest peak-to-average power ratio (PAPR) for transmission to the access point 602. For instance, the transmitter 690 may perform the same or similar operations for producing and transmitting a pilot sequence with a lowest peak-to-average power ratio (PAPR) as performed by the access point 602. Thus, for example, the transmitter 690 may obtain data 694, generate a pilot sequence, scramble the pilot sequence, insert the pilot sequence, rotate the pilot sequence and/or transmit the data and pilot sequence (with lowest PAPR) similar to the access point 602.

In some configurations, the access point 602 may include a receiver 684 for receiving data and/or pilot symbols. For example, the access point 602 may receive data and/or a pilot sequence with a lowest PAPR from the access terminal 642. The receiver 684 may include a channel estimation block/module 686, which may perform channel estimation in a similar manner as the channel estimation block/module 660 included in the access terminal 642. For instance, the access point 602 may use a pilot sequence with a lowest PAPR received from the access terminal 642 to characterize the channel, transmitter (e.g., access terminal 642) impairments and/or receiver (e.g., access point 602) impairments. The access point 602 may use this characterization to detect, decode, demodulate, etc. one or more signals received from the access terminal 642. For instance, the receiver 684 may similarly perform one or more operations performed by the access terminal 642. In other words, the receiver 684 may similarly perform one or more operations to obtain received data 682 that are performed by the access terminal 642 to obtain its received data 644.

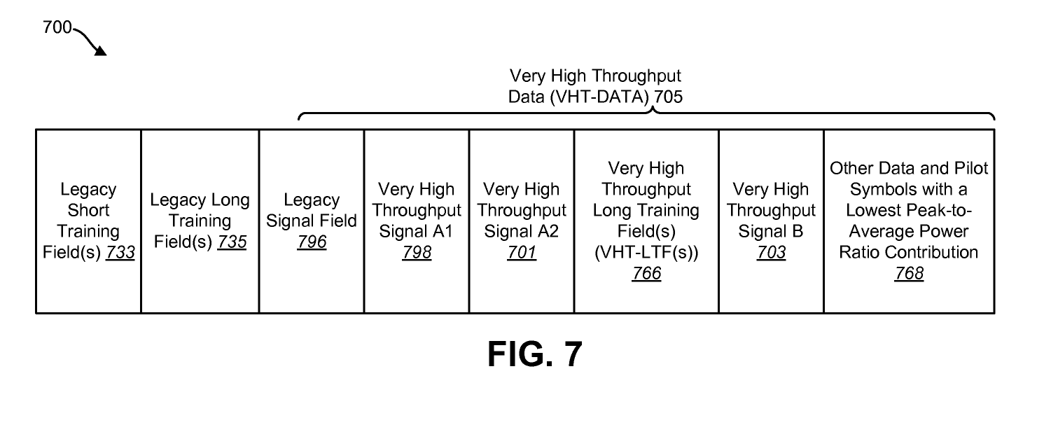

FIG. 7 is a diagram illustrating one example of a transmission frame 700 that may be used in accordance with the systems and methods disclosed herein. The frame 700 may include one or more very high throughput long training fields (VHT-LTFs) 766. The very high throughput long training field(s) (VHT-LTF(s)) 766 may include pilot symbols and/or other symbols that may be used (by a receiving communication device 142, for example) to synchronize, detect, demodulate and/or decode data included in the frame 700. The frame 700 may additionally or alternatively include one or more legacy short training fields 733 and/or one or more legacy long training fields 735 (according to IEEE 802.11 specifications, for example).

The frame 700 may include a very high throughput data (VHT-DATA) field 705. The very high throughput data (VHT-DATA) field 705 may include one or more fields, signals and/or symbols. For example, the VHT-DATA field 705 may include a legacy signal field 796, a very high throughput signal A1 798, a very high throughput signal A2 701, one or more VHT-LTFs 766 and/or a very high throughput signal B 703. In one configuration, this legacy signal field 796 and signals A1 798, A2 701 and B 703 may be used according to IEEE 802.11 specifications. For example, a pseudo-random noise sequence for scrambling may be offset by z=4 as described above to accommodate the legacy signal field 796 and signals A1 798, A2 701 and B 703.

The frame 700 (e.g., VHT-DATA field 705) may include other data and/or pilot symbols with a lowest peak-to-average power ratio (PAPR) contribution 768 (in conjunction with the VHT-LTFs 766, for instance). For example, a pilot sequence (e.g., pilot symbols) with a lowest peak-to-average power ratio (PAPR) combined with data symbols may be sent as part of the VHT-DATA field 705. For example, the other data and pilot symbols with a lower PAPR contribution 768 may include one or more orthogonal frequency-division multiplexing (OFDM) symbols. One or more of the OFDM symbols may include pilot symbols comprising a pilot sequence with a lowest PAPR contribution (to the OFDM symbols) interspersed with data symbols. More specifically, one or more of the OFDM subcarriers may include pilot symbols while one or more of the other OFDM subcarriers may include data symbols. In one configuration, the symbols or elements of a pilot sequence [1 1 1 −1 −1 1 1 1] (that has been rotated to [1 1 −1 1 1 −1 −1 −1] using a 20 MHz subband rotation [1 −1 −1 −1], for example) may be inserted at OFDM subcarriers with indices k={−103, −75, −39, −11, 11, 39, 75, 103}. The pilot symbols may be used by a receiving communication device (e.g., access point 602, access terminal 642) to characterize the communication channel, transmitter impairments and/or receiver impairments, to track phase and/or frequency offsets, to compensate for impairments and/or offsets and/or to detect, demodulate and/or decode received data.

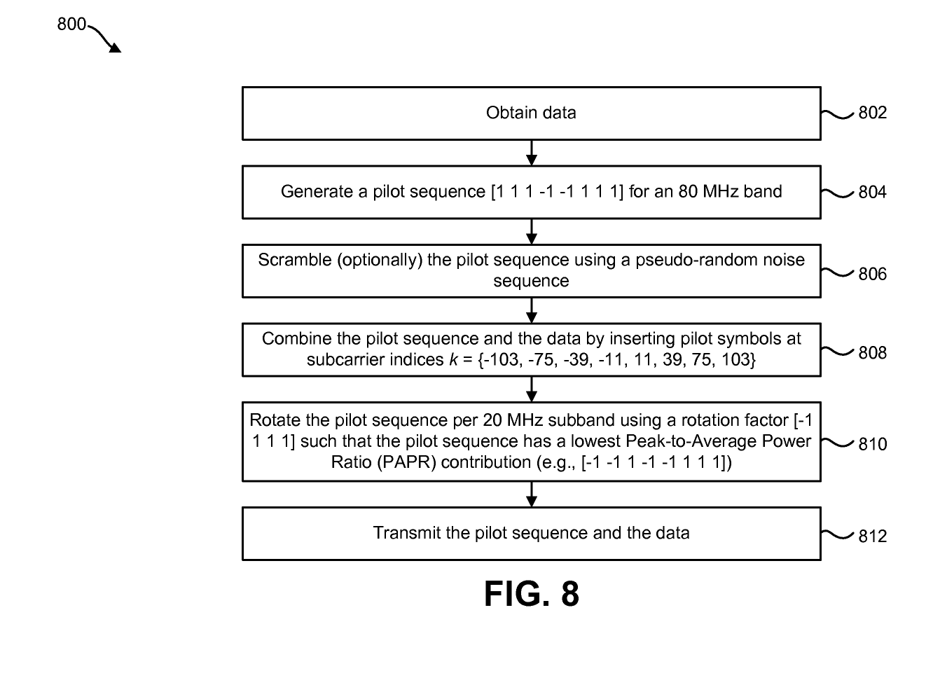

FIG. 8 is a flow diagram illustrating a more specific configuration of a method 800 for transmitting a pilot sequence. An access point 602 may obtain 802 data 604. For example, an access point 602 may receive data 604 from a network, receive input data 604 from an input device (e.g., mouse, keyboard, microphone, controller, etc.), retrieve data 604 from local and/or removable electronic memory (e.g., a hard drive, thumb drive, external drive, random access memory (RAM), etc.) and/or obtain data 604 from some other device.

The access point 602 may generate 804 a pilot sequence [1 1 1 −1 −1 1 1 1] 632. For example, the access point 602 may generate a sequence of pilot symbols [1 1 1 −1 −1 1 1 1] for an 80 MHz frequency band. In one configuration, the access point 602 retrieves a pattern from memory that may be used to generate 804 a pilot sequence [1 1 1 −1 −1 1 1 1] 632. For example, the pattern data may represent the pilot sequence 632 using bits that indicate a [1 1 1 −1 −1 1 1 1] pilot sequence 632. In one configuration, a pilot generator 630 may use this pattern data to generate pilot symbols with a phase and/or amplitude that reflects the pilot sequence 632. For instance, the pilot generator 630 may generate a pilot sequence 632 with an orthogonal frequency-division multiplexing (OFDM) symbol with a particular amplitude and/or phase for each “1” and an OFDM symbol with a different amplitude and/or phase for each “−1.”

The access point 602 may optionally scramble 806 the pilot sequence [1 1 1 −1 −1 1 1 1] 632 using a pseudo-random noise sequence. For example, the access point 602 may use a pseudo-random noise generator 628 to generate a pseudo-random noise (PN) sequence. The pilot sequence 632 may be multiplied by the PN sequence in order to scramble 806 the pilot sequence 632.

The access point 602 may combine 808 the pilot sequence [1 1 1 −1 −1 1 1 1] 632 and the data 604. For example, the access point 602 may insert one or more pilot symbols (from the pilot sequence [1 1 1 −1 −1 1 1 1] 632) with the data (symbols) 604. When orthogonal frequency-division multiplexing (OFDM) is used, for instance, the access point 602 may insert the pilot symbols from the pilot sequence [1 1 1 −1 −1 1 1 1] 632 at particular tones or subcarrier 640 indices k={−103, −75, −39, −11, 11, 39, 75, 103}. One or more of the other subcarriers 640 may be used for data symbols.

The access point 602 may rotate 810 the pilot sequence 632 such that the pilot sequence [1 1 1 −1 −1 1 1 1] has a lowest peak-to-average power ratio (PAPR) contribution 634. For example, the access point 602 may multiply the pilot sequence [1 1 1 −1 −1 1 1 1] 632 by a rotation or multiplication factor [1 −1 −1 −1]. In one configuration, an 80 MHz band may be used for transmission of the pilot and data symbols. The 80 MHz band may include four 20 MHz subbands 688a-d. The access point 602 may use a rotation factor [1 −1 −1 −1]. Each of the rotation factor elements [1 −1 −1 −1] may correspond to each of the four 20 MHz subbands 688a-d. In the case where the elements or pilot symbols of a pilot sequence [1 1 1 −1 −1 1 1 1] 632 are mapped or inserted into subcarriers corresponding to 20 MHz subbands, the rotation factor [1 −1 −1 −1] may rotate a pilot sequence [1 1 1 −1 −1 1 1 1] 632 such that the last six elements or symbols are inverted, resulting in a pilot sequence [1 1 −1 1 1 −1 −1 −1] with a lowest peak-to-average power ratio (PAPR) contribution 634.

The access point 602 may transmit 812 the pilot sequence (e.g., pilot sequence with a lowest PAPR contribution 634) and the data 604. For example, the access point 602 may transmit OFDM symbols that include the pilot sequence and the data 604 using one or more antennas 636a-n. It should be noted that in some configurations, an access terminal 642 may similarly perform the method 800 in order to transmit a pilot sequence with a lowest PAPR contribution.

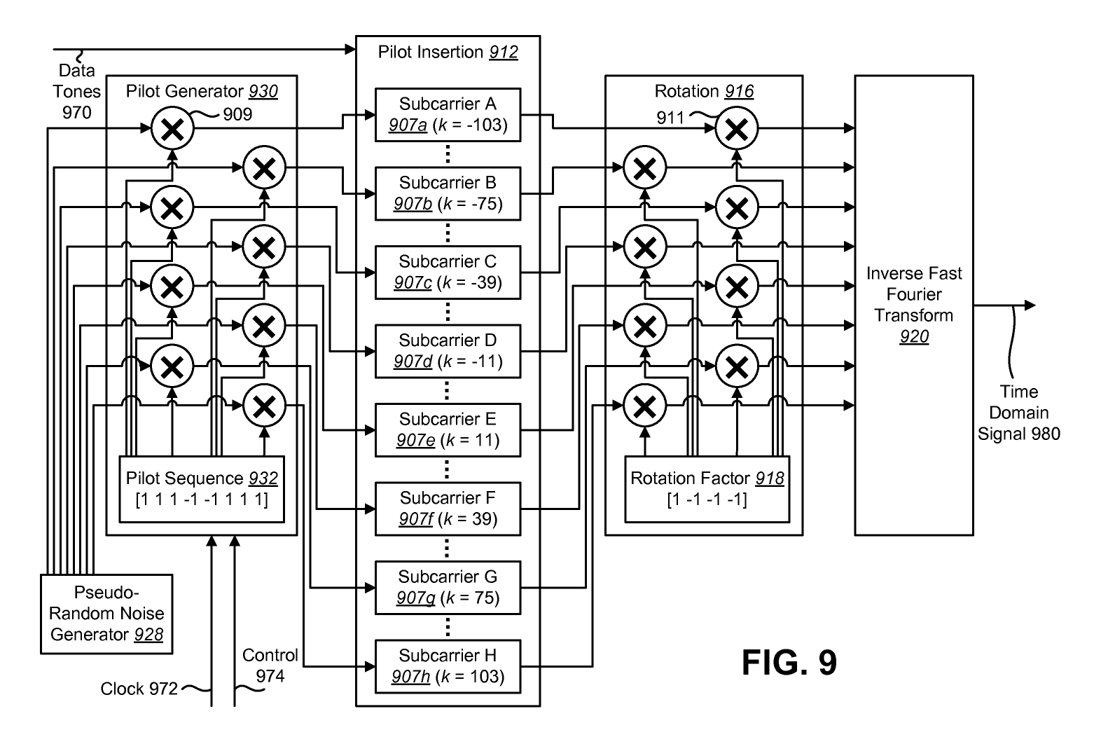

FIG. 9 is a block diagram illustrating a more detailed example of several blocks/modules that may be used to produce a pilot sequence with a lowest peak-to-average power (PAPR) contribution. More specifically, FIG. 9 illustrates more detail of one example of a portion of an access point 602 or access terminal 642. As described above, data tones 970 (from a modulation mapper 610 or the like) and pilot tones (from a pilot generator 930, for example) may be provided to an inverse fast Fourier transform (IFFT) block/module 920. For example, the data tones 970 and the pilot tones (occupying different frequency subcarriers 907) may be applied to different taps of the IFFT block/module 920 to produce a time-domain signal 980.

In this example, the particular pilot tones that are inserted by a pilot insertion block/module 912 are driven by a pilot tone generator (e.g., pilot generation circuitry) 930. The pilot tone generator 930 may determine the amplitude and/or phase of pilot tones. This may be done for each pilot tone, for each symbol period and/or for each spatial stream 638.

The pilot generator 930 may generate a pilot sequence 932. The values of the pilot tones may be derived from a control signal 974 and optionally a pseudo-random noise (PN) generator 928. For example, the pseudo-random noise generator 928 may generate values that are multiplied by the pilot sequence 932. Furthermore, the control signal 974 may specify a particular pilot sequence 932 for use. For example, the control signal 974 may specify that a pilot sequence 932 of [1 1 1 −1 −1 1 1 1] should be used for an 80 MHz transmission.

More specifically, for instance, the pseudo-random noise generator 928 may generate eight values to be multiplied by the eight values of the pilot sequence [1 1 1 −1 −1 1 1 1] 932. As illustrated in FIG. 9, the pilot generator 930 includes multipliers 909. It should be noted that one or more of the multipliers 909 in the pilot generator 930 may be referred to using the reference number 909. The multipliers 909 may be used to multiply eight pseudo-random noise (PN) values with the eight values [1 1 1 −1 −1 1 1 1] in the pilot sequence 932. More specifically, a first value 1 (of the pilot sequence 932) may be multiplied with a first PN value, a second value 1 may be multiplied with a second PN value, a third value 1 may be multiplied with a third PN value, a fourth value −1 may be multiplied with a fourth PN value and so on for the eight pilot sequence [1 1 1 −1 −1 1 1 1] 932 values.

The pilot generator 930 may also use a clock signal 972. For instance, the clock signal 972 may indicate a symbol period. A pilot sequence 932 or elements of the pilot sequence 932 may be generated for each symbol period, for example. Thus, in a symbol period, the pilot generator 930 may specify an amplitude and/or a phase for each of one or more pilot tones (over one or more of spatial streams 138, for example).

In one configuration, the pilot tone value for a pilot subcarrier may be considered constant over a symbol period and may or may not change from one particular symbol period to the next. Thus, the values may be referred to as “pilot symbols”. The pilot generator 930 may comprise logic to determine, for a plurality of pilot tone subcarriers 907 (and/or a plurality of spatial streams 638), which pilot tone symbols to provide for those subcarriers 907 during each symbol period.

In one configuration, the pilot generator 930 may generate a pilot sequence 932 [1 1 1 −1 −1 1 1 1]. For example, the pilot generator 930 may determine the amplitude and/or phase of a pilot sequence 932 of eight pilot tones using the pattern [1 1 1 −1 −1 1 1 1]. For example, a particular amplitude and/or phase of eight pilot tones may indicate the pattern [1 1 1 −1 −1 1 1 1]. These eight pilot tones (optionally multiplied by PN values) may be provided to the pilot insertion block/module 912, which may intersperse the eight pilot tones amongst data tones 970 in order to generate an orthogonal frequency-division multiplexing (OFDM) symbol.

As illustrated in FIG. 9, the pilot insertion block/module 912 may insert the pilot tones into particular subcarriers 907a-h. More specifically, the pilot insertion block/module 912 may a first pilot tone (e.g., “1”) into subcarrier A 907a at index k=−103, a second pilot tone (e.g., “1”) into subcarrier B 907b at index k=−75, a third pilot tone (e.g., “1”) into subcarrier C 907c at index k=−39, a fourth pilot tone (e.g., “−1”) into subcarrier D 907d at index k=−11, a fifth pilot tone (e.g., “−1”) into subcarrier E 907e at index k=11, a sixth pilot tone (e.g., “1”) into subcarrier F 907f at index k=39, a seventh pilot tone (e.g., “1”) into subcarrier G 907g at index k=75 and an eighth pilot tone (e.g., “1”) into subcarrier H 907h at index k=103. The data tones 970 (and/or other signals, data, tones or nothing) may be inserted into other subcarriers. The pilot tones and/or data tones 970 (and/or other signals, data, tones or nothing) may comprise an OFDM symbol that is output from the pilot insertion block/module 912.

The OFDM symbol may be provided to a rotation block/module (e.g., rotation circuitry) 916. The rotation block/module 916 may use a rotation factor 918 to rotate the OFDM symbol. In one configuration, the rotation factor 918 comprises a pattern of [1 −1 −1 −1], with each element corresponding to a particular subband (e.g., a range of subcarriers 907). For example, each of the values may correspond to a 20 MHz subband in an 80 MHz band. Assume, for instance, that the first two pilot symbols in the pilot sequence 932 are included in a first 20 MHz subband. The first value of the rotation factor 918 is a 1 (in this example), and thus the first two pilot symbols in the pilot sequence 932 may be multiplied by the first rotation factor 918 element (“1”) and so on. Thus, the rotation block/module 916 may produce a (rotated) pilot sequence that indicates a pattern of [1 1 −1 1 1 −1 −1 −1]. Corresponding data symbols may also be rotated. This (rotated) pilot sequence may contribute the lowest peak-to-average power ratio to the transmitted signal.

More specifically, the rotation block/module 916 may include multipliers 911. It should be noted that the reference number 911 may be used to refer to one or more of the multipliers included in the rotation block/module 916. In one specific example, the pilot tones that were inserted into subcarriers A 907a (at k=−103) and B 907b (at k=−75) may be multiplied by the first element of the rotation factor 918. In this example, the remainder of the pilot tones inserted at subcarriers C-H 907c-h may be multiplied by the remainder of the rotation factor 918 elements. For instance, the pilot tones inserted on subcarriers C and D 907c-d may be multiplied by the second element (−1) of the rotation factor 918, the pilot tones inserted on subcarriers E and F 907e-f may be multiplied by the third element (−1) of the rotation factor 918 and the pilot tones inserted on subcarriers G and H 907g-h may be multiplied by the fourth element (−1) of the rotation factor 918. Alternatively, those pilot tones that would be multiplied by a factor of 1 may not be multiplied, but passed through the rotation block/module 916. It should be noted that data tones 970 corresponding to a 20 MHz subband with a rotation factor 918 element of −1 may also be multiplied or rotated.

The (rotated) pilot sequence and data (as an OFDM symbol, for example) may be provided by the rotation block/module 916 to an inverse fast Fourier transform (IFFT) block/module 920. It should be noted that this (rotated) pilot sequence may contribute a lowest PAPR. Each OFDM subcarrier (e.g., including a pilot tone, data tone 970, signal, other tone or nothing) may be provided to a different tap of an IFFT function. The IFFT block/module 920 may convert the (rotated) pilot sequence and data to a time-domain signal 980.

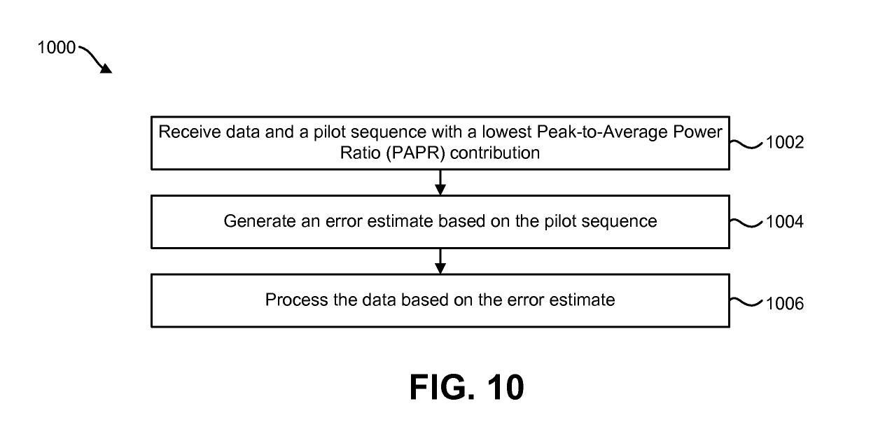

FIG. 10 is a flow diagram illustrating one configuration of a method 1000 for using a pilot sequence with a lowest peak-to-average power ratio (PAPR) contribution. A receiving communication device 142 (e.g., access point 602, access terminal 642) may receive 1002 data and a pilot sequence with a lowest PAPR contribution. In some configurations, the receiving communication device 142 may convert the received signal from an analog signal to a digital signal, synchronize the received signal in time and/or frequency, deformat (e.g., unscramble, remove a cyclic prefix, etc.) the received signal and/or perform a fast Fourier transform (FFT) on the received signal, etc.

The receiving communication device 142 may generate 1004 an error estimate based on the pilot sequence. For example, the receiving communication device 142 may use the pilot sequence to determine phase offsets/errors and/or frequency offsets/errors caused by the channel, transmitter impairments and/or receiver impairments. For example, the pilot sequence may be used to track and compensate for phase offset(s), frequency offset(s), timing drift and/or amplitude drift. In some configurations, the pilot sequence is “known” on the receiving communication device 142. Thus, the known pilot sequence may be used (in comparison to the received pilot sequence, for example) to determine these phase and/or frequency offsets/errors.

The receiving communication device 142 may process 1006 the received data based on the error estimate. Processing 1006 the received data may include detecting, demodulating, decoding and/or other processing. For example, the receiving communication device 142 may compensate for errors in the received data based on the error estimate. In this way, the receiving communication device 142 may improve data reception.

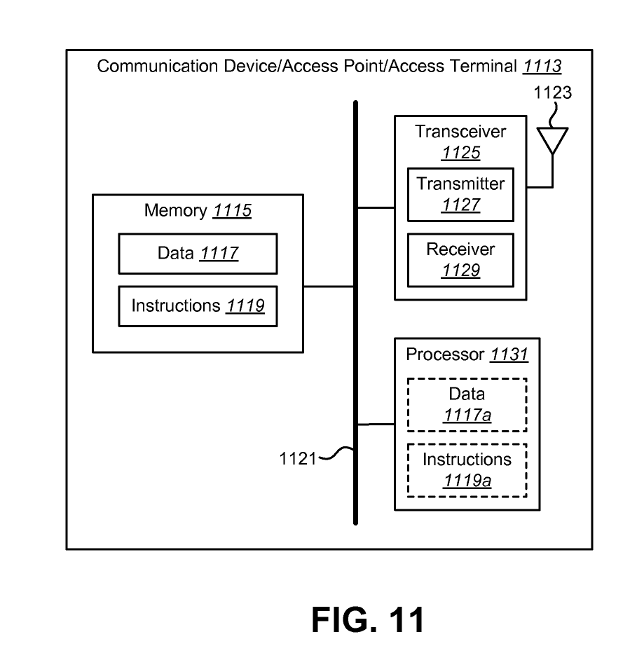

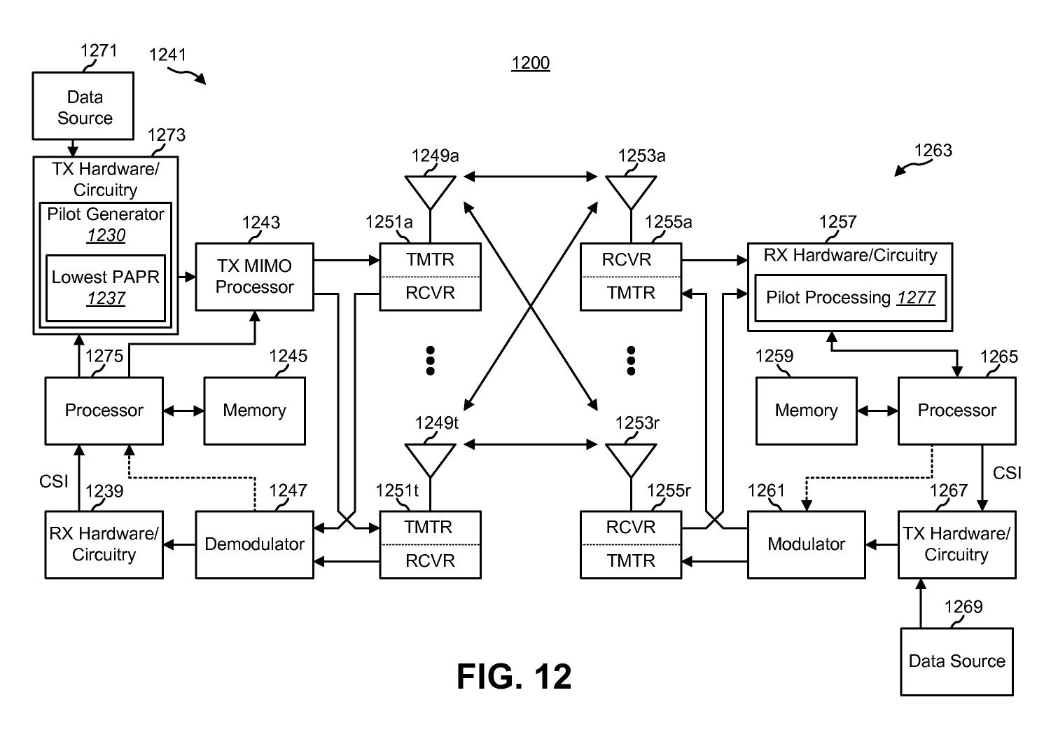

FIG. 11 illustrates certain components that may be included within a communication device, access point and/or access terminal 1113. The transmitting communication device 102, receiving communication device 142, access point 602 and/or access terminal 642 described above may be configured similarly to the communication device/access point/access terminal 1113 that is shown in FIG. 11.

The communication device/access point/access terminal 1113 includes a processor 1131. The processor 1131 may be a general purpose single- or multi-chip microprocessor (e.g., an ARM), a special purpose microprocessor (e.g., a digital signal processor (DSP)), a microcontroller, a programmable gate array, etc. The processor 1131 may be referred to as a central processing unit (CPU). Although just a single processor 1131 is shown in the communication device/access point/access terminal 1113 of FIG. 11, in an alternative configuration, a combination of processors (e.g., an ARM and DSP) could be used.

The communication device/access point/access terminal 1113 also includes memory 1115 in electronic communication with the processor 1131 (i.e., the processor 1131 can read information from and/or write information to the memory 1115). The memory 1115 may be any electronic component capable of storing electronic information. The memory 1115 may be random access memory (RAM), read-only memory (ROM), magnetic disk storage media, optical storage media, flash memory devices in RAM, on-board memory included with the processor, programmable read-only memory (PROM), erasable programmable read-only memory (EPROM), electrically erasable PROM (EEPROM), registers, and so forth, including combinations thereof.

Data 1117 and instructions 1119 may be stored in the memory 1115. The instructions 1119 may include one or more programs, routines, sub-routines, functions, procedures, code, etc. The instructions 1119 may include a single computer-readable statement or many computer-readable statements. The instructions 1119 may be executable by the processor 1131 to implement the methods 300, 500, 800, 1000 described above. Executing the instructions 1119 may involve the use of the data 1117 that is stored in the memory 1115. FIG. 11 shows some instructions 1119a and data 1117a being loaded into the processor 1131.

The communication device/access point/access terminal 1113 may also include a transmitter 1127 and a receiver 1129 to allow transmission and reception of signals between the communication device/access point/access terminal 1113 and a remote location (e.g., another communication device, access terminal, access point, etc.). The transmitter 1127 and receiver 1129 may be collectively referred to as a transceiver 1125. An antenna 1123 may be electrically coupled to the transceiver 1125. The communication device/access point/access terminal 1113 may also include (not shown) multiple transmitters, multiple receivers, multiple transceivers and/or multiple antenna.

The various components of the communication device/access point/access terminal 1113 may be coupled together by one or more buses, which may include a power bus, a control signal bus, a status signal bus, a data bus, etc. For simplicity, the various buses are illustrated in FIG. 11 as a bus system 1121.

FIG. 12 is a block diagram of a transmitter 1241 and receiver 1263 in a multiple-input and multiple-output (MIMO) system 1200. Examples of transmitters 1241 may include transmitting communication devices 102, access points 602, access terminals 642 and/or a communication device, access point and/or access terminal 1113. Additionally or alternatively, examples of receivers 1263 may include receiving communication devices 142, access points 602, access terminals 642 and/or a communication device, access point and/or access terminal 1113. In the transmitter 1241, traffic data for a number of data streams is provided from a data source 1271 to a transmit (TX) hardware/circuitry 1273. Each data stream may then be transmitted over a respective transmit antenna 1249a-t. The TX hardware/circuitry 1273 may format, code and interleave the traffic data for each data stream based on a particular coding scheme selected for that data stream to provide coded data.

The TX hardware/circuitry 1273 may perform the one or more of the methods 300, 500, 800 disclosed herein. In one configuration, the TX hardware/circuitry 1273 may comprise one or more blocks of dedicated hardware or circuitry used to perform baseband physical layer (PHY) tasks. For instance, the TX hardware/circuitry 1273 may comprise dedicated hardware or circuitry to map data bits to constellation points, which are interleaved by dedicated hardware (which may or may not be included in the TX hardware/circuitry 1273) and fed to appropriate tone inputs (e.g., data tones) of an IFFT block/module (which may or may not be included in the TX hardware/circuitry). Parallel to that, a pilot generator or generation circuitry 1230 (which may be dedicated hardware or circuitry included in the TX hardware/circuitry 1273) generates a pilot sequence with a lowest peak-to-average power ratio contribution 1237 (abbreviated as “Lowest PAPR” in FIG. 12 for convenience) and/or the pilot mapping and feeds that to the appropriate tones (e.g., pilot tones) at the input of an IFFT block/module (which may or may not be included in the TX hardware/circuitry 1273).

In another configuration, the TX hardware/circuitry 1273 may be a generic processor. For example, a generic processor could be used so long as it is fast enough to process at a particular data rate (e.g., up to 5 gigabits per second (Gbps)). For instance, the TX hardware/circuitry 1273 may execute instructions in order to cause a pilot generator 1230 to generate a pilot sequence with a lowest peak-to-average power (PAPR) contribution 1237.

It should be noted that having a pilot sequence with a lowest PAPR contribution 1237 may be beneficial for the transmitter 1241 because for low PAPR transmissions, the transmitter 1241 may not need to be linear over a large amplitude range. Thus, having a pilot sequence with a lowest PAPR contribution 1237 may save power or may save on transmitter 1241 implementation cost.

The coded data for each data stream may be multiplexed with pilot data (e.g., reference signals) using orthogonal frequency-division multiplexing (OFDM) techniques. The pilot data may be a known data pattern that is processed in a known manner and used at the receiver 1263 to estimate the channel response. The multiplexed pilot and coded data for each stream is then modulated (i.e., symbol mapped) based on a particular modulation scheme (e.g., binary phase shift keying (BPSK), quadrature phase shift keying (QPSK), multiple phase shift keying (M-PSK) or multi-level quadrature amplitude modulation (M-QAM)) selected for that data stream to provide modulation symbols. The data rate, coding and modulation for each data stream may be determined by instructions performed by a processor.

The modulation symbols for all data streams may be provided to a transmit (TX) multiple-input multiple-output (MIMO) processor 1243, which may further process the modulation symbols (e.g., for OFDM). The transmit (TX) multiple-input multiple-output (MIMO) processor 1243 then provides NT modulation symbol streams to NT transmitters (TMTR) 1251a through 1251t. The TX transmit (TX) multiple-input multiple-output (MIMO) processor 1243 may apply beamforming weights to the symbols of the data streams and to the antenna 1249 from which the symbol is being transmitted.

Each transmitter 1251 may receive and process a respective symbol stream to provide one or more analog signals, and further condition (e.g., amplify, filter, and upconvert) the analog signals to provide a modulated signal suitable for transmission over the MIMO channel. NT modulated signals from transmitters 1251a through 1251t are then transmitted from NT antennas 1249a through 1249t, respectively.

At the receiver 1263, the transmitted modulated signals are received by NR antennas 1253a through 1253r and the received signal from each antenna 1253 is provided to a respective receiver (RCVR) 1255a through 1255r. Each receiver 1255 may condition (e.g., filter, amplify, and downconvert) a respective received signal, digitize the conditioned signal to provide samples, and further process the samples to provide a corresponding “received” symbol stream.

RX hardware/circuitry 1257 then receives and processes the NR received symbol streams from NR receivers 1255 to provide NT “detected” symbol streams. The RX hardware/circuitry 1257 then demodulates, deinterleaves and decodes each detected symbol stream to recover the traffic data for the data stream. The tasks performed by the RX hardware/circuitry 1257 may be complementary to that performed by the TX MIMO processor 1243 and the TX hardware/circuitry 1273 at transmitter 1241.

The RX hardware/circuitry 1257 may perform pilot processing 1277. For example, the RX hardware/circuitry 1257 may perform the method 1000 illustrated in FIG. 10. In one configuration, the RX hardware/circuitry may comprise one or more dedicated hardware and/or circuitry blocks used to perform pilot processing. For example, the RX hardware/circuitry 1257 may use a received pilot sequence to track and/or compensate for a common phase offset, frequency offset, timing drift, and/or amplitude drift. It should be noted that RX hardware/circuitry 1257 may use a pilot sequence whether or not the pilot sequence has a lowest PAPR contribution.

In another configuration, the RX hardware/circuitry 1257 may comprise a generic processor. For example, the RX hardware/circuitry 1257 may execute instructions in order to perform the method 1000 illustrated in FIG. 10. More specifically, the RX hardware/circuitry 1257 may process a pilot sequence with a lowest peak to average power ratio (PAPR) contribution in accordance with the systems and methods disclosed herein.

A processor 1265 may periodically determine which pre-coding matrix to use. The processor 1265 may store information on and retrieve information from memory 1259. The processor 1265 formulates a reverse link message comprising a matrix index portion and a rank value portion. The reverse link message may be referred to as channel state information (CSI). The reverse link message may comprise various types of information regarding the communication link and/or the received data stream. The reverse link message is then processed by a TX data processor 1267, which also receives traffic data for a number of data streams from a data source 1269, modulated by a modulator 1261, conditioned by transmitters 1255a through 1255r, and transmitted back to the transmitter 1241.

At the transmitter 1241, the modulated signals from the receiver are received by antennas 1249, conditioned by receivers 1251, demodulated by a demodulator 1247, and processed by an RX data processor 1239 to extract the reverse link message transmitted by the receiver 1263. A processor 1275 may receive channel state information (CSI) from the RX data processor 1239. The processor 1275 may store information on and retrieve information from memory 1245. The processor 1275 then determines which pre-coding matrix to use for determining the beamforming weights and then processes the extracted message. The transmitting communication device 102 discussed above may be configured similarly to the transmitter 1241 illustrated in FIG. 12. The receiving communication device 142 discussed above may be configured similarly to the receiver 1263 illustrated in FIG. 12.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL) or wireless technologies such as infrared, radio and microwave, then the coaxial cable, fiber optic cable, twisted pair, DSL or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A communication device for transmitting a pilot sequence, comprising:
pilot generation circuitry configured for generating a pilot sequence with a reduced peak-to-average power ratio contribution after rotation; and
transmitter circuitry configured for transmitting the pilot sequence.

2. The communication device of claim 1, wherein the pilot sequence comprises a pilot sequence [1 1 1 −1 −1 1 1 1].

3. The communication device of claim 1, further comprising rotation circuitry configured for rotating the pilot sequence such that the pilot sequence has a lowest peak-to-average power ratio contribution.

4. The communication device of claim 3, wherein the pilot sequence is included in four subbands and pilot symbols corresponding to the four subbands are rotated using a rotation factor [1 −1 −1 −1] or its inverse.

5. The communication device of claim 4, wherein the four subbands are each 20 megahertz (MHz) subbands.

6. The communication device of claim 3, wherein the pilot sequence comprises a pilot sequence [1 1 −1 1 1 −1 −1 −1] or its inverse after rotation.

7. The communication device of claim 1, wherein the pilot sequence is combined with data, and wherein the transmitter circuitry is further configured to transmit the data.

8. The communication device of claim 7, wherein the pilot sequence and the data comprise a very high throughput data (VHT-DATA) field.

9. The communication device of claim 1, wherein the pilot generation circuitry is further configured to multiply the pilot sequence by one or more pseudo-random noise values.

10. The communication device of claim 1, wherein the pilot sequence comprises one or more orthogonal frequency-division multiplexing (OFDM) symbols.

11. The communication device of claim 1, wherein the communication device is an access point.

12. The communication device of claim 1, wherein the communication device is an access terminal.

13. A method for transmitting a pilot sequence by a communication device, comprising:
generating a pilot sequence with a reduced peak-to-average power ratio contribution after rotation; and
transmitting the pilot sequence.

14. The method of claim 13, wherein the pilot sequence comprises a pilot sequence [1 1 1 −1 −1 1 1 1].

15. The method of claim 13, further comprising rotating the pilot sequence such that the pilot sequence has a lowest peak-to-average power ratio contribution.

16. The method of claim 15, wherein the pilot sequence is included in four subbands and pilot symbols corresponding to the four subbands are rotated using a rotation factor [1 −1 −1 −1] or its inverse.

17. The method of claim 16, wherein the four subbands are each 20 megahertz (MHz) subbands.

18. The method of claim 15, wherein the pilot sequence comprises a pilot sequence [1 1 −1 1 1 −1 −1 −1] or its inverse after rotation.

19. The method of claim 13, wherein the pilot sequence is combined with data, and wherein the method further comprises transmitting the data.

20. The method of claim 19, wherein the pilot sequence and the data comprise a very high throughput data (VHT-DATA) field.

21. The method of claim 13, further comprising multiplying the pilot sequence by one or more pseudo-random noise values.

22. The method of claim 13, wherein the pilot sequence comprises one or more orthogonal frequency-division multiplexing (OFDM) symbols.

23. The method of claim 13, wherein the communication device is an access point.

24. The method of claim 13, wherein the communication device is an access terminal.

25. A computer-program product for transmitting a pilot sequence, comprising a non-transitory tangible computer-readable medium having instructions thereon, the instructions comprising:
code for causing a communication device to generate a pilot sequence with a reduced peak-to-average power ratio contribution after rotation; and
code for causing the communication device to transmit the pilot sequence.

26. The computer-program product of claim 25, wherein the pilot sequence comprises a pilot sequence [1 1 1 −1 −1 1 1 1].

27. The computer-program product of claim 25, wherein the instructions further comprise code for causing the communication device to rotate the pilot sequence such that the pilot sequence has a lowest peak-to-average power ratio contribution.

28. An apparatus for transmitting a pilot sequence, comprising:
means for generating a pilot sequence with a reduced peak-to-average power ratio contribution after rotation; and
means for transmitting the pilot sequence.

29. The apparatus of claim 28, wherein the pilot sequence comprises a pilot sequence [1 1 1 −1 −1 1 1 1].

30. The apparatus of claim 28, further comprising means for rotating the pilot sequence such that the pilot sequence has a lowest peak-to-average power ratio contribution.

31. A communication device for transmitting a pilot sequence, comprising:
pilot generation circuitry configured for generating a pilot sequence with reduced cyclic correlation over frequency; and
transmitter circuitry configured for transmitting the pilot sequence.

32. The communication device of claim 31, wherein the pilot sequence comprises a pilot sequence [1 1 1 −1 −1 1 −1 1].

33. The communication device of claim 31, wherein the pilot sequence is combined with data, and wherein the transmitter circuitry is further configured to transmit the data.

34. A method for transmitting a pilot sequence by a communication device, comprising:
generating a pilot sequence with reduced cyclic correlation over frequency; and
transmitting the pilot sequence.

35. The method of claim 34, wherein the pilot sequence comprises a pilot sequence [1 1 1 −1 −1 1 −1 1].

36. The method of claim 34, wherein the pilot sequence is combined with data, and wherein the method further comprises transmitting the data.
